(19) United States
(12) Patent Application Publication
(10) Pub. No.: US 2010/0080173 A1
(43) Pub. Date: Apr. 1, 2010

(54) APPARATUS AND METHOD FOR WIRELESS COMMUNICATION

(75) Inventor: Masahiro TAKAGI, Tokyo (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: KABUSHIKI KAISHA TOSHIBA

(21) Appl. No.: 12/551,107

(22) Filed: Aug. 31, 2009

(30) Foreign Application Priority Data
Sep. 26, 2008 (JP) 2008-248318

(51) Int. Cl. H04W 4/00; H04N 11/04

(52) U.S. Cl. 370/328; 375/240.01

(57) ABSTRACT

A first storage stores a first number of streams which are capable of being demultiplexed by the wireless communication apparatus. A first acquisition unit acquires a second number of streams which are capable of being demultiplexed by a first wireless communication apparatus. A second acquisition unit acquires a third number of sum of streams of communications performed by the wireless communication apparatus and the first wireless communication apparatus. A second storage stores, if the first number of streams exceeds the third number of streams, a difference between the first and third numbers of streams as an allowable number of streams. A determination unit determines that a wireless medium is idle, in the case where a number of streams required for perform a new communication is not more than the allowable number of streams.

### CROSS-REFERENCE TO RELATED APPLICATIONS

This application is based upon and claims the benefit of priority from prior Japanese Patent Application No. 2008-248318, filed Sep. 26, 2008, the entire contents of which are incorporated herein by reference.

### BACKGROUND OF THE INVENTION

1. Field of the Invention

The present invention relates to apparatus and method for wireless communication in which a plurality of streams are spatially multiplexed.

2. Description of the Related Art

Media access control (MAC) is control which is used for a plurality of communication apparatuses that share an identical medium to determine how to use the medium to transmit communication data. The MAC can eliminate a phenomenon (so-called a collision) in which a communication apparatus on the receiving side cannot demultiplex communication data even when two or more communication apparatuses simultaneously transmit communication data using an identical medium. Also, the MAC can reduce a phenomenon in which a medium is not used by any of communication apparatuses, although a communication apparatus having a transmission request exists.

In wireless communications, it is difficult for a communication apparatus to monitor transmission data while transmitting data. Thus, MAC which is not premised on collision detection is required. IEEE802.11 as the typical technical standard of a wireless LAN (Local Area Network) adopts CSMA/CA (Carrier Sense Multiple Access with Collision Avoidance).

In the CSMA/CA of the IEEE802.11, in a header of a MAC frame, a period (called a duration) until a series of sequences including one or more frame exchanges after that MAC frame is set. A communication apparatus which is not related to the sequences in the duration and has no right of transmission waits for transmission by determining a virtual occupation state of media. As a result, occurrence of collision is avoided. On the other hand, a communication apparatus which has the right of transmission in the sequences recognizes that the medium is idle except for a duration in which the medium is actually occupied.

The IEEE802.11 specifies that the media state is determined by a combination of a virtual carrier sense of a MAC layer as the former case and a physical carrier sense of a physical layer as the latter case, and MAC is executed based on the media state.

IEEE802.11n, at present, specifications of which are under development, plans to incorporate MIMO (Multiple Input Multiple Output) technique that increases the transmission speed using a plurality of transmission antennas and a plurality of reception antennas.

Recent papers have discussed Multi User MIMO (MU-MIMO) that enhances the MIMO in the form of a combination with SDMA (Spatial Division Multiplex Access). With MU-MIMO, for example, a base station simultaneously transmits independent MIMO streams (two streams from one base station to each of two terminals, i.e., a total of four streams) to a plurality of terminals not to interfere with each other, or conversely, a plurality of terminals simultaneously transmit independent MIMO streams to a single base station.

The CSMA/CA MAC of the IEEE802.11n permits only one-to-one communications between wireless communication apparatuses and cannot be compatible with MU-MIMO. For example, a technique that combines CSMA-like MAC as in the IEEE802.11 and MU-MIMO, JP-A 2005-192127 (KOKAI) is known.

The IEEE802.11n plans to increase to a maximum of four MIMO streams (4-stream multiplexing). In order to further increase the transmission speed and capacity more than the IEEE802.11n, increasing the multiplexing order of the MIMO can be one of choices due to limitations on the frequency band. However, in consideration of limitations on the cost, consumption power, and size of a wireless communication apparatus, not all apparatuses which configure a network can allow maximum MIMO multiplexing in many situations. In the conventional CSMA/CA, since it is determined that a medium is busy during a communication of an apparatus with a low possible degree of multiplexing, the network communication capacity cannot be fully used even in a situation in which another apparatus with a high possible degree of multiplexing further allows MIMO multiplexing (spatial division multiplex access). Therefore, a technique that can fully use the network communication capacity while allowing the scalabilities (especially, different numbers of antennas in this case) of apparatuses according to service requests is demanded. For this purpose, it is proposed to apply the MU-MIMO to a wireless LAN.

Since a frequency band used in a wireless LAN can freely use wireless communication apparatuses without any license unlike a cellular network that requires the license, it is difficult to control communications not to interfere with each other when a base station consolidates terminals. For this reason, a media access system that allows distributed control like the CSMA is preferable.

Above mentioned JP-A 2005-192127 (KOKAI) partially achieves the above object, but it is insufficient in points exemplified below.

(1) The network communication capacity cannot be fully utilized when wireless communication apparatuses having various numbers of antennas exist. For example, it is required that the total number of antennas on the transmitting apparatus side is equal to or smaller than a minimum value of the number of antennas of the receiving apparatus. However, even when this requirement is not satisfied, the spatial division multiplex access can often be implemented when, for example, the transmitting apparatus uses antennas that exceed the number of transmission streams as degrees of freedom used to remove an interference.

(2) It has proposed that an idle OFDM subcarrier is assigned to a MIMO stream based on a certain rule so as to be used as a busy tone (signature signal). This allows to detect only an idle/busy status of a duration in which a wireless communication apparatus which attempts to transmit a signal makes a carrier sense, but a future status is unknown. For this reason, even when transmission is started by determining “idle” at a certain instance, a combination of wireless communication apparatuses which parallelly perform a transmission/reception during the duration in which that transmission continues may be changed, and an interference may occur. Note that in the IEEE802.11, since no carrier sense is made when, for example, an ACK frame is transmitted in response to a received DATA frame, such interference is more likely to occur when the transmission and reception sides are switched.

(3) Since an idle OFDM subcarrier is assigned to a MIMO stream based on a certain rule so as to be used as a busy tone (signature signal), the number of available OFDM subcarriers decreases with increasing a maximum MIMO multiplexing order in a system.

### BRIEF SUMMARY OF THE INVENTION

According to the first aspect of the present invention, there is provided a wireless communication apparatus comprising: a first storage to store a first number of streams which are capable of being demultiplexed by the wireless communication apparatus in present and future communications of a time series; a first acquisition unit configured to acquire a second number of streams which are capable of being demultiplexed by a first wireless communication apparatus involved in the communications; a second acquisition unit configured to acquire a third number of sum of streams of communications at a time point of the time series performed by the wireless communication apparatus and the first wireless communication apparatus; a second storage to store, if the first number of streams exceeds the third number of streams, a difference between the first number of streams and the third number of streams as an allowable number of streams; and a determination unit configured to determine that a wireless medium is idle, in the case where a fourth number of streams required for the wireless communication apparatus to perform a new communication is not more than the allowable number of streams.

### BRIEF DESCRIPTION OF THE SEVERAL VIEWS OF THE DRAWING

FIG. 1 is a block diagram showing a wireless communication apparatus according to an embodiment;

FIG. 2 is a view showing a physical frame;

FIG. 3 is a view showing a request to send frame;

FIG. 4 is a view showing a clear to send frame;

FIG. 5 is a view showing a data frame;

FIG. 6 is a view showing a wireless communication apparatus network;

FIG. 7 is a chart showing a frame exchange;

FIG. 8 is a view showing the first example;

FIG. 9 is a view showing carrier sense state management (1) of the first example;

FIG. 10 is a view showing carrier sense state management (2) of the first example;

FIG. 11 is a chart showing another frame exchange;

FIG. 12 is a view showing the second example;

FIG. 13 is a view showing carrier sense state management (1) of the second example;

FIG. 14 is a view showing carrier sense state management (2) of the second example;

FIG. 15 is a chart showing still another frame exchange;

FIG. 16 is a view showing the third example;

FIG. 17 is a view showing carrier sense state management (1) of the third example;

FIG. 18 is a view showing carrier sense state management (2) of the third example;

FIG. 19 is a chart showing still another frame exchange;

FIG. 20 is a view showing the fourth example;

FIG. 21 is a view showing carrier sense state management (1) of the fourth example;

FIG. 22 is a view showing carrier sense state management (2) of the fourth example;

FIG. 23 is a view showing a request to send frame of the conventional format;

FIG. 24 is a view showing a clear to send frame of the conventional format;

FIG. 25 is a chart showing still another frame exchange;

FIG. 26 is a view showing the fifth example;

FIG. 27 is a view showing an HT control field;

FIG. 28 is a view showing a control wrapper frame; and

FIG. 29 is a view showing an example in which a conventional wireless communication apparatus and a wireless communication apparatus according to the embodiment of the present invention time-divisionally coexist.

### DETAILED DESCRIPTION OF THE INVENTION

Embodiments of the present invention will be described hereinafter with reference to the drawings.

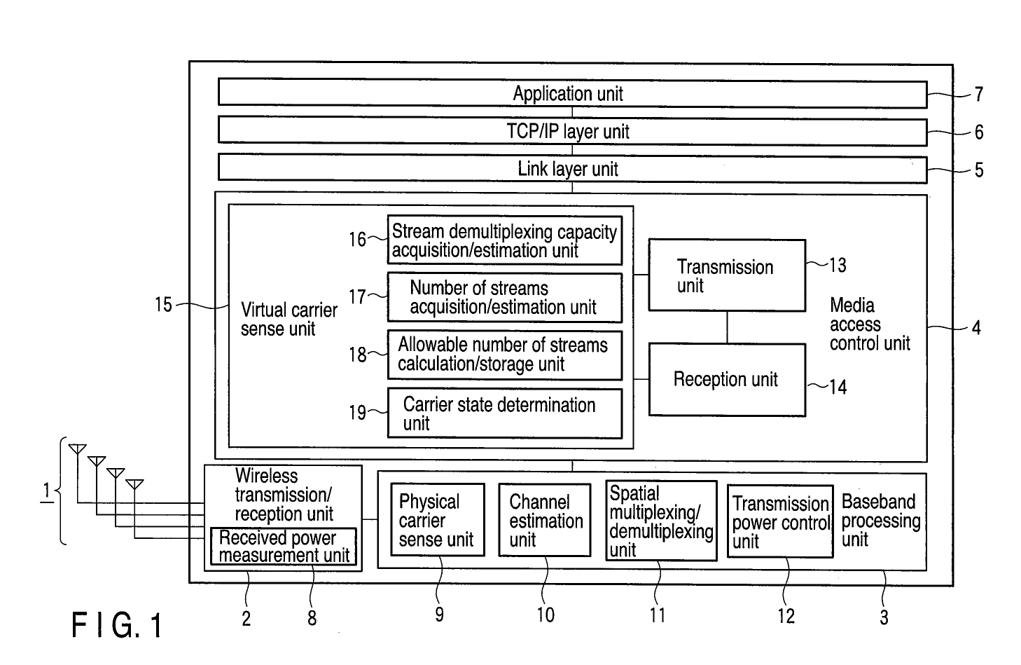

Referring to FIG. 1, a wireless communication apparatus includes antennas 1, a wireless transmission/reception unit 2, baseband processing unit 3, media access control unit 4, link layer unit 5, TCP/IP layer unit 6, and application unit 7. This embodiment assumes a wireless LAN specified by the IEEE802.11, but the present invention can be carried out without being limited to the IEEE802.11 wireless LAN.

This embodiment assumes application of a so-called MIMO (Multiple Input Multiple Output) technology, but an SISO wireless communication apparatus can be used as long as it can coexist with a MIMO wireless communication apparatus in a media access control system to be described below. When a wireless communication apparatus can implement the MIMO, there is a plurality of antennas 1, but the numbers of transmission and reception antennas may be different. When a wireless communication apparatus implements only the SISO, it may have only one antenna 1, but may have a plurality of antennas that can be switched for, e.g., space diversity use.

The wireless transmission/reception unit 2 can include a general arrangement (not shown) such as a switch used to switch connections between the antennas 1 and transmission unit/reception unit, transmission and reception bandpass filters, a low noise amplifier for reception, a power amplifier for transmission, a frequency conversion function between the frequency handled by the baseband processing unit 3 and a wireless frequency, analog-to-digital conversion for converting a received signal into a digital signal that can be handled by the baseband processing unit 3, and digital-to-analog conversion for converting a digital transmission signal from the baseband processing unit 3 into an analog signal. Received power information by a received power measurement unit 8 is used to control the gain of the low noise amplifier. Also, the received power information is input to a physical carrier sense unit 9 of the baseband processing unit 3, and is used to determine whether a medium is physically idle or busy.

The baseband processing unit 3 includes a general arrangement (not shown) such as synchronization, a modulation/demodulation function, an interleaver/deinterleaver, encoder/decoder, and scrambler/descrambler.

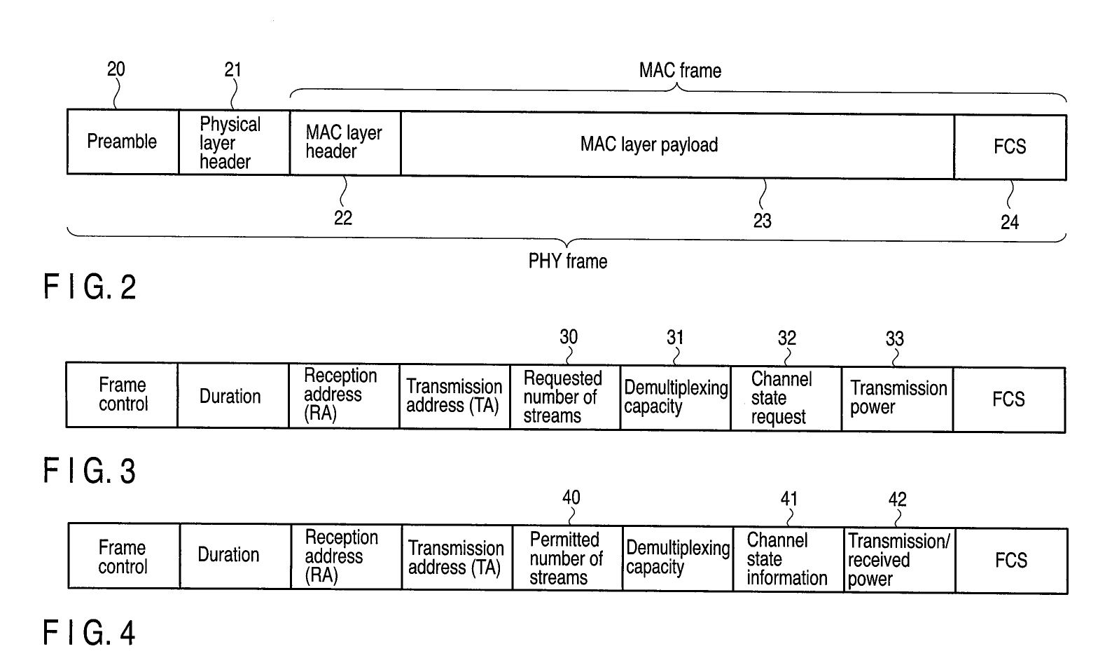

The physical carrier sense unit 9 determines, based on the received power information from the received power measurement unit 8 of the wireless transmission/reception unit 2, and information for a frame length and modulation and coding schemes included in a physical layer header (see FIG. 2), whether a medium is idle or busy. The received power is used to determine instantaneous idle/busy information, but the information (the frame length and the modulation and coding schemes) in the physical layer header is used to determine whether or not a continuous duration of a frame is busy. For example, determination may be made by a method described in the specifications of the IEEE802.11. Note that in this embodiment, even when the physical layer carrier sense determines “busy”, when the spatial division multiplex access based on the MIMO is further allowed, a virtual carrier sense unit 15 may determine an idle medium, as will be described later, and such determination result is different from the carrier sense result of the conventional IEEE802.11.

A channel estimation unit 10 implements a function of estimating, based on a known signal included in a preamble of a physical (PHY) frame (see FIG. 2), channel information between a wireless communication apparatus that transmitted the physical frame and the self wireless communication apparatus on the receiving side. Since the MIMO is assumed, the channel estimation unit 10 generally obtains matrix channel information between antennas on the transmitting side and those on the receiving side. Also, the channel estimation unit 10 implements a function of accumulating channel information obtained previously, and searching for and using the accumulated information in response to a request.

A spatial multiplexing/demultiplexing unit 11 multiplexes a plurality of transmission MIMO streams by giving appropriate weights to them (also to prevent any forward interference), or demultiplexes a received signal into individual MIMO streams (also to remove an unnecessary interference signal).

A transmission power control unit 12 controls the magnitude of transmission power in accordance with a request mainly from the media access control unit 4. For example, the transmission power control unit 12 appropriately controls the gain of the power amplifier in the wireless transmission/reception unit 2 and pre-processing in the baseband processing unit 3.

The media access control unit 4 includes a transmission unit 13 which executes transmission processing, a reception unit 14 which executes reception processing, and the virtual carrier sense unit 15 which determines an idle/busy status of a medium based on logical information exchanged by a media access protocol.

The virtual carrier sense unit 15 includes a stream demultiplexing capacity acquisition/estimation unit 16, a number of streams acquisition/estimation unit 17, an allowable number of streams calculation/storage unit 18, and a carrier state determination unit 19. The unit 16 acquires or estimates stream demultiplexing capacities of respective wireless communication apparatuses involved in the present to future communications of a certain time series. The unit 17 acquires or estimates the numbers of streams of communications made at respective time points of the time series. The unit 18 stores, when the stream demultiplexing capacity exceeds the number of streams during a given duration of the time series, their difference as the allowable number of streams. The unit 19 determines that a wireless medium is in an idle state for transmissions within a range of the allowable number of streams.

FIG. 2 shows an example of the format of a frame which is transmitted from or received by the wireless communication apparatus according to this embodiment with the aforementioned arrangement.

A PHY frame (or PPDU: PHY Protocol Data Unit) includes a preamble 20, physical layer header 21, and MAC frame (corresponding to a physical layer payload). The preamble 20 is a known signal used to establish synchronization of timings and frequencies, and to estimate a channel. In general, it is a common practice to make known signals for channel estimation be orthogonal to each other by an arbitrary method, so as to independently estimate channels of respective antennas or respective MIMO streams (an antenna and MIMO stream often have a one-to-one correspondence, but three antennas may also transmit or receive two streams). The preamble 20 may have a configuration as adopted in, e.g., the IEEE802.11n.

The physical layer header 21 mainly includes information required to decode a MAC frame and, for example, information such as a frame length, modulation scheme, and coding scheme. These pieces of information are also used by the physical carrier sense unit 9 to determine a medium idle/busy status, as described above. That is, the physical carrier sense unit 9 calculates a data rate based on the modulation scheme and coding scheme, and can determine, based on this data rate and the frame length, that a medium is busy during a duration time of a frame.

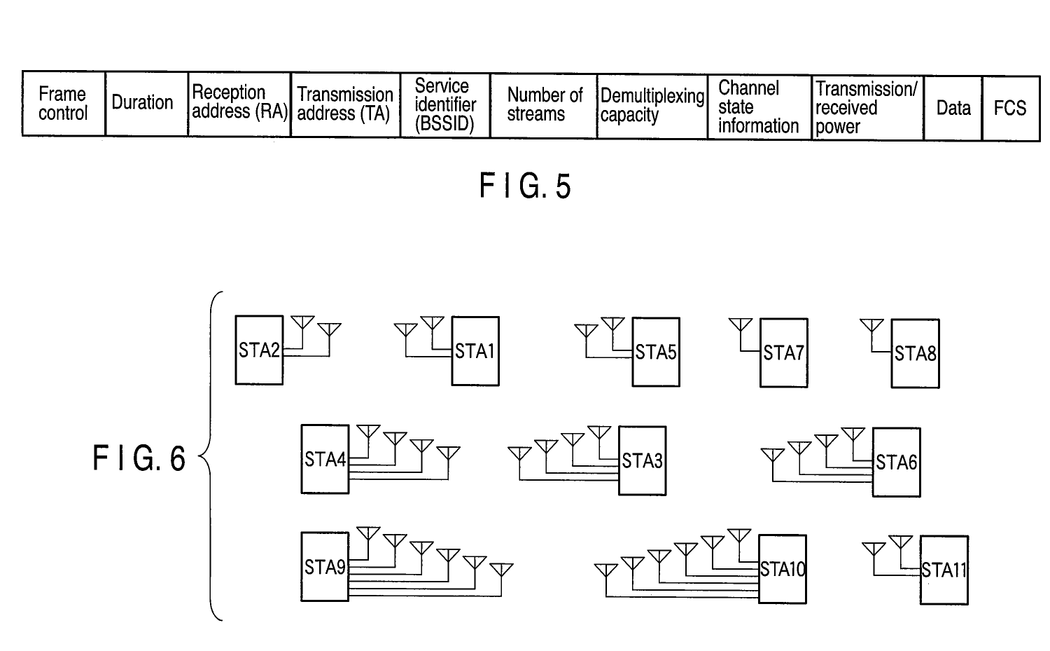

The MAC frame (or MPDU: MAC Protocol Data Unit) includes a MAC layer header 22, MAC layer payload 23, and FCS 24. As examples of the MAC frame, FIG. 3 shows an example of the format of a request to send frame (to be referred to as an MU-RTS frame hereinafter) according to the present invention, FIG. 4 shows that of the format of a clear to send frame (to be referred to as an MU-CTS frame hereinafter) according to the present invention, and FIG. 5 shows that of the format of a data frame (to be referred to as DATA frame hereinafter) according to the present invention. These frames are obtained by expanding an RTS frame, CTS frame, and DATA frame specified by the existing IEEE802.11 to allow to exchange information required for the present invention. Exchange of these frames, and use of respective fields that configure each frame will be practically explained in the following embodiment.

A requested number of streams field 30 is set with a request value of the number of streams of a DATA frame which is transmitted by a wireless communication apparatus that transmits an MU-RTS frame after exchange of MU-RTS and MU-CTS frames, and is used to negotiate the number of streams with each other. A demultiplexing capacity field 31 is used to notify another wireless communication apparatus of the demultiplexing capacity of a wireless communication apparatus itself which transmits an MU-RTS, MU-CTS, or DATA frame. A channel state request field 32 is used when a wireless communication apparatus which transmits an MU-RTS frame requests a wireless communication apparatus on the receiving side to return a channel state. A transmission power field 33 is set with an MU-RTS transmission power value by a wireless communication apparatus which transmits an MU-RTS frame, and is used to allow a wireless communication apparatus on the receiving side to estimate a transmission channel loss. A permitted number of streams field 40 is used when a wireless communication apparatus which receives an MU-RTS frame and transmits an MU-CTS frame replies the number of streams, which is equal to or smaller than the number of streams requested in the requested number of streams field 30 in the MU-RTS frame and can be received by the self wireless apparatus during a requested time period in consideration of surrounding communication circumstances. A channel state information field 41 is used when a wireless communication apparatus which is requested to return a channel state and transmits an MU-CTS or DATA frame returns the channel state to a wireless communication apparatus on the request side. Note that the channel state information field 41 may include information that requests to return a channel state. A transmission power value part of a transmission/received power field 42 is set with a transmission power value of an MU-CTS or DATA frame by a wireless communication apparatus which transmits the MU-CTS or DATA frame, and is used to allow a wireless communication apparatus on the receiving side to estimate a transmission channel loss. A received power part of the transmission/received power field 42 is set with a received power value of a frame (e.g., MU-RTS frame) received just before by a wireless communication apparatus which transmits an MU-CTS or DATA frame, and is used to inform a wireless communication apparatus on the receiving side and surrounding wireless communication apparatuses of a transmission channel loss between apparatuses.

An acknowledgement frame (to be referred to as a BA frame hereinafter) can use a Block Ack frame specified by the conventional IEEE802.11n.

Referring back to FIG. 2, the MAC layer header 22 includes a frame control field including a protocol version, frame type, and other kinds of control information, a duration field indicating a scheduled duration in which a medium is occupied, and information such as the addresses of wireless communication apparatuses involved in transmission and reception, a service identifier (BSSID) used to identify a group of wireless communication apparatuses, the requested number of streams, the permitted number of streams, spatial multiplexing/demultiplexing capacity, a request of channel state information and a response of channel state information to that request, transmission power, and received power.

The MAC layer payload 23 includes data in case of a data frame, but it does not often include any data, as exemplified by a request to send frame and clear to send frame classified as control frames.

The FCS 24 includes CRC information calculated in association with the MAC layer header 22 and MAC layer payload 23 so as to detect errors which may be generated in the MAC layer header 22 and MAC layer payload 23. When errors of the MAC layer header 22 and MAC layer payload 23 are to be independently detected, independent CRC values may be calculated for them.

Note that a plurality of MAC frames may be coupled to a single PHY payload like A-MPDU adopted in the IEEE802.11n. In this case, information required to demultiplex respective MAC frames is added in an appropriate format.

Fields which are added to RTS, CTS, and DATA frames of the conventional IEEE802.11 in association with the MU-RTS frame shown in FIG. 3, the MU-CTS frame shown in FIG. 4, and the DATA frame shown in FIG. 5 will be briefly described below. The requested number of streams field 30 is set with a request value of the number of streams of a DATA frame which is transmitted by a wireless communication apparatus that transmits an MU-RTS frame after exchange of MU-RTS and MU-CTS frames, and is used to negotiate the number of streams with each other. The demultiplexing capacity field 31 is used to notify another wireless communication apparatus of the demultiplexing capacity of a wireless communication apparatus itself which transmits an MU-RTS, MU-CTS, or DATA frame. The channel state request field 32 is used when a wireless communication apparatus which transmits an MU-RTS frame requests a wireless communication apparatus on the receiving side to return a channel state. The transmission power field 33 is set with an MU-RTS transmission power value by a wireless communication apparatus which transmits an MU-RTS frame, and is used to allow a wireless communication apparatus on the receiving side to estimate a transmission channel loss. The permitted number of streams field 40 is used when a wireless communication apparatus which receives an MU-RTS frame and transmits an MU-CTS frame replies the number of streams, which is equal to or smaller than the number of streams requested in the requested number of streams field 30 in the MU-RTS frame and can be received by the self wireless apparatus during a requested period of time in consideration of surrounding communication circumstances. The channel state information field 41 is used when a wireless communication apparatus which is requested to return a channel state and transmits an MU-CTS or DATA frame returns the channel state to a wireless communication apparatus on the request side. Note that the channel state information field 41 may include information that requests to return a channel state. A transmission power value part of the transmission/received power field 42 is set with a transmission power value of an MU-CTS or DATA frame by a wireless communication apparatus which transmits the MU-CTS or DATA frame, and is used to allow a wireless communication apparatus on the receiving side to estimate a transmission channel loss. A received power part of the transmission/received power field 42 is set with a received power value of a frame (e.g., MU-RTS frame) received just before by a wireless communication apparatus which transmits an MU-CTS or DATA frame, and is used to inform a wireless communication apparatus on the receiving side and surrounding wireless communication apparatuses of a transmission channel loss between apparatuses.

Referring to FIG. 6, an example of a network configured by a plurality of wireless communication apparatuses is shown. Assume that each of wireless communication apparatuses STA1, STA2, and STA5 has two antennas to have a spatial multiplexing/demultiplexing capacity up to a maximum of two streams. Assume that each of wireless communication apparatuses STA3, STA4, and STA6 has four antennas to have a spatial multiplexing/demultiplexing capacity up to a maximum of four streams. Assume that each of wireless communication apparatuses STA7 and STA8 has one antenna to have a spatial multiplexing/demultiplexing capacity up to a maximum of one stream (or to have no spatial multiplexing/demultiplexing capacity).

Assume that each of wireless communication apparatuses STA9 and STA10 has six antennas to have a spatial multiplexing/demultiplexing capacity up to a maximum of six streams.

On the other hand, a wireless communication apparatus STA11 is an apparatus based on the existing IEEE802.11n specifications, and has two antennas to have a spatial multiplexing capacity up to a maximum of two streams. That is, the wireless communication apparatus STA11 can transmit a maximum of two streams to one arbitrary wireless communication apparatus, and can receive a maximum of two streams transmitted from one arbitrary wireless communication apparatus. However, during the communication with a desired wireless communication apparatus, the wireless communication apparatus STA11 does not have any function of canceling an interference from another apparatus or suppressing a forward interference to another apparatus unlike the wireless communication apparatuses according to the embodiment of the present invention.

Note that all the wireless communication apparatuses may operate in a so-called ad-hoc mode in which they serve as equal terminals or in an infrastructure mode in which one of wireless communication apparatuses serves as a base station to manage other wireless communication apparatuses. This is the same case as that an IEEE802.11 system as well as a base station operates based on the media access control of the CSMA/CA.

Assume that all the wireless communication apparatuses are ready to receive PHY frames transmitted by other wireless communication apparatuses (in a situation in which a wireless medium is shared) in FIG. 6. In this situation, assume that the apparatus STA2 transmits a PHY frame including two streams to the apparatus STA1. In the normal CSMA/CA adopted in the conventional IEEE802.11, all other wireless communication apparatuses determine that the medium is busy during the frame transmission, and cannot make any communications. However, for example, using the spatial multiplexing/demultiplexing capacities of the apparatuses STA4 and STA3, the apparatus STA4 can concurrently transmit a PHY frame including two streams to the apparatus STA3 without interfering with the STA2-STA1 communication. On the other hand, since the apparatuses STA5, STA7, and STA8 do not have sufficient spatial multiplexing/demultiplexing capacities, they cannot concurrently transmit frames without interfering with the STA2-STA1 communication. Therefore, in this example, when the apparatus STA4 attempts to transmit a frame to the apparatus STA3, it can recognize the medium as an idle state up to two streams, and the apparatuses STA5, STA7, and STA8 can recognize the medium as a busy state. When the media access control that can control transmission according to the idle/busy states can be implemented, the frequency use efficiency can be improved.

Such method will be described in detail below while giving examples.

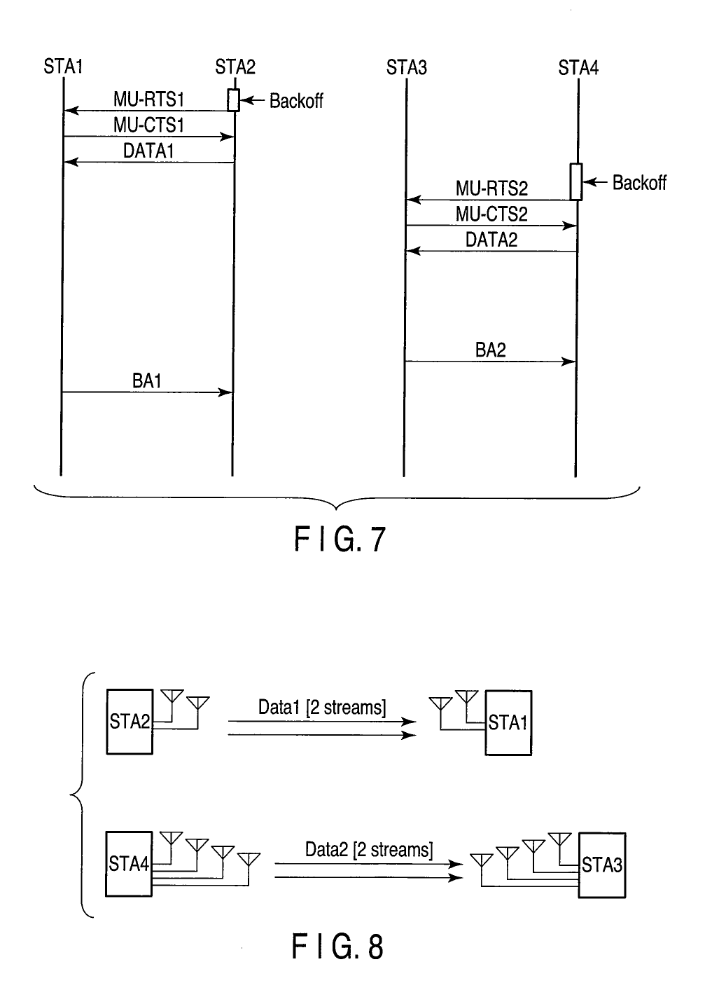

FIG. 7 shows an example of frame exchange to be discussed below. FIG. 8 shows the combination contents of assumed wireless communication apparatuses and frame transmissions in association with the first example in which a plurality of wireless communication apparatuses parallelly make communications. An overview of the sequence will be explained here, and details of processes required in respective stages will be described later.

As shown in FIG. 7, the wireless communication apparatus STA2 determines that the medium is idle, executes backoff processing, and then transmits a request to send frame MU-RTS1 (multi-user request to send) to the wireless communication apparatus STA1. When the wireless communication apparatus STA1 determines that it can receive transmission according to the requested contents, it returns a clear to send frame MU-CTS1 (multi-user clear to send) to the wireless communication apparatus STA2. The wireless communication apparatus STA2 detects that the requested transmission can be done, since it receives the frame MU-CTS1, and transmits a data frame DATA1 to the wireless communication apparatus STA1.

During transmission of the data frame DATA1, the wireless communication apparatus STA4 detects that it can concurrently transmit up to two streams, based on the information previously exchanged using the frames MU-RTS1 and MU-CTS1 and the spatial multiplexing/demultiplexing capacity of the self wireless communication apparatus. In this case, when the wireless communication apparatus STA4 also detects the spatial multiplexing/demultiplexing capacity of the wireless communication apparatus STA3 in addition to the above information, it can more accurately determine whether or not to allow to transmit, but this knowledge is not indispensable.

The wireless communication apparatus STA4 transmits a request to send frame MU-RTS2 that requests to transmit two streams to the wireless communication apparatus STA3. When the wireless communication apparatus STA3 determines that it can receive transmission according to the requested contents, it returns a clear to send frame MU-CTS2 to the wireless communication apparatus STA4. The wireless communication apparatus STA4 detects that the requested transmission can be done, since it receives the frame MU-CTS2, and transmits a data frame DATA2 to the wireless communication apparatus STA3.

Upon completion of reception of the data frame DATA2, the wireless communication apparatus STA3 transmits an acknowledgement frame BA2 (Block Ack) having the contents according to the reception result to the wireless communication apparatus STA4. Note that transmission of the frame BA2 is controlled to start after completion of transmission of the frame DATA1 and to end before completion of transmission of a frame BA1. On the premise of this control, the duration field of the frame MU-RTS2 is set. This is required to determine whether or not to complete the scheduled parallel transmission by the given spatial multiplexing/demultiplexing capacity without causing any interference.

Upon completion of reception of the data frame DATA1, the wireless communication apparatus STA1 transmits an acknowledgement frame BA1 (Block Ack) having the contents according to the reception result to the wireless communication apparatus STA2.

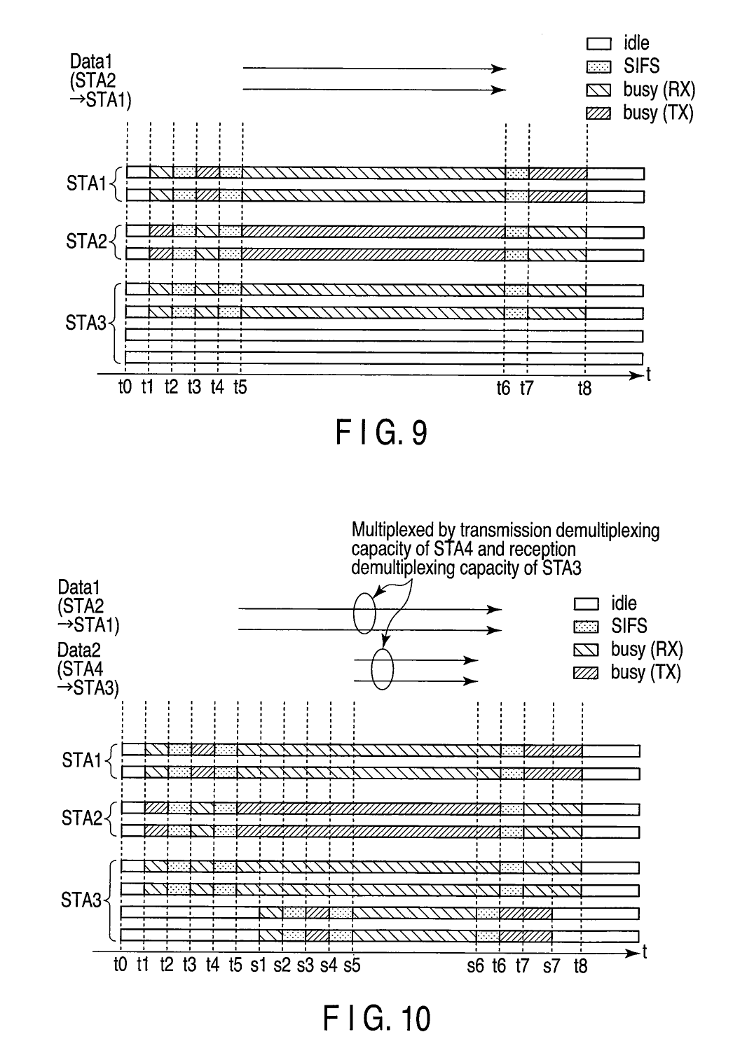

Information and the like required for the wireless communication apparatus STA4 to make a carrier sense in case of the aforementioned operations will be described below in association with carrier sense state management (1) of the first example in which a plurality of wireless communication apparatus pairs parallelly make communications shown in FIG. 9, and carrier sense state management (2) of the first example in which a plurality of wireless communication apparatus pairs parallelly make communications shown in FIG. 10.

Although the operations of the related wireless communication apparatuses will be explained below, since a characteristic feature lies in the operation of the wireless communication apparatus STA4 which determines to start a communication parallel to a communication which has already been started between the wireless communication apparatuses STA2 and STA1, and that of the wireless communication apparatus STA3 which makes a communication to be paired with the apparatus STA4, these operations will be focused in the following description.

In FIGS. 9 and 10, a time flows from the left to the right. Assume that during an interval of an initial state between time points t0 and t1, none of the wireless communication apparatuses STA1 to STA11 perform transmission, and a medium is unconditionally idle when viewed from all the wireless communication apparatuses.

The wireless communication apparatus STA2 decrements a backoff counter during this interval, and begins to transmit the request to send frame MU-RTS1 which requests to transmit a data frame DATA1 that includes two streams and requires a duration of t6-t5 seconds to the wireless communication apparatus STA1 at a time point t1 when the backoff counter reaches zero. At time point t2, the transmission of the frame MU-RTS1 ends. The wireless communication apparatus STA1 determines that this transmission request can be received, since the medium is completely idle and it can receive the requested data frame DATA1 within the range of the spatial multiplexing/demultiplexing capacity of the self apparatus (up to 2-stream multiplexing) under this condition. Then, the wireless communication apparatus STA1 begins to transmit the clear to send frame MU-CTS1 to the wireless communication apparatus STA2 at time point t3 after an elapse of an SIFS (Shortest Inter Frame Space). The transmission of the frame MU-CTS1 ends at time point t4.

The wireless communication apparatus STA4 monitors the request to send frame MU-RTS1. The wireless communication apparatus STA4 measures received power using the received power measurement unit 8 of the wireless transmission/reception unit 2 to control the gain of the low noise amplifier, and sends the information to the physical carrier sense unit 9 so as to determine a carrier idle/busy status.

The wireless communication apparatus STA4 stores this information in the transmission unit 13 of the media access control unit 4 so as to be used as information used to estimate the degree of forward interference to the wireless communication apparatus STA1 when it transmits a frame. However, since the identifier (MAC address) of the wireless communication apparatus STA2 is included in a MAC frame, an associating process between this information and the wireless communication apparatus STA2 as the transmission source is completed after decoding of the MAC frame ends later. Associating processes between the wireless communication apparatus STA2 and various kinds of information will be completed at similar time point as above, although they are not especially described.

The baseband processing unit 3 of the wireless communication apparatus STA4 executes required synchronization processing. Furthermore, the channel estimation unit 10 of the wireless communication apparatus STA4 estimates channel information with the wireless communication apparatus STA2 using the preamble 20 of the request to send frame MU-RTS1. This information is used to decode the physical layer header 21 and MAC frame. In addition, this information is stored in the transmission unit 13 of the media access control unit 4 as that used to control the spatial multiplexing/demultiplexing unit 11 so as to prevent a frame to be transmitted by the wireless communication apparatus STA4 from interfering with the wireless communication apparatus STA2. Assume that the preamble 20 is added to have the configuration that gives information associated with all the antennas of the wireless communication apparatus STA2.

The baseband processing unit 3 of the wireless communication apparatus STA4 demultiplexes MIMO streams of the frame MU-RTS1 using the spatial multiplexing/demultiplexing unit 11 if necessary, and also demodulates the physical layer header 21. Information of a modulation scheme, coding scheme, and frame length included in the physical layer header 21 is used to decode the MAC frame, and is also sent to the physical carrier sense unit 9.

The physical carrier sense unit 9 of the wireless communication apparatus STA4 calculates a data rate based on the modulation scheme and coding scheme, and calculates a frame duration of time based on this data rate and the frame length. As a result, it can be determined that a medium for two streams is busy during an interval between time points t1 to t2. Assume that information associated with the number of transmission frames is included in the modulation scheme.

The physical carrier sense unit 9 of the wireless communication apparatus STA4 sends up information associated with received power and information indicating that the medium for two streams is busy in a duration between time points t1 and t2 to the virtual carrier sense unit 15 of the media access control unit 4. At this time point, the stream demultiplexing capacity acquisition/estimation unit 16 does not have any information associated with the wireless communication apparatus STA2, and has only information associated with the self apparatus STA4 (a maximum of 4-stream multiplexing/demultiplexing). The number of streams acquisition/estimation unit 17 has information indicating that two streams are occupied in the duration between time points t1 and t2. However, since the MAC frame is not decoded yet, the number of streams acquisition/estimation unit 17 does not recognize at this time point that these two streams are transmitted from the wireless communication apparatus STA2 to the wireless communication apparatus STA1. If it is not recognized that no interference has to be yielded to the wireless communication apparatus STA1 as a destination, a forward interference to the wireless communication apparatus STA1 cannot be suppressed by controlling the spatial multiplexing/demultiplexing unit 11 upon making transmission. Therefore, the permitted number of streams storage unit records that the permitted number of streams is zero in the duration between time points t1 and t2. Then, when the transmission unit 13 sends an inquiry for an idle/busy status to the virtual carrier sense unit 15, the carrier state determination unit 19 determines and replies “busy”.

The media access control unit 4 of the wireless communication apparatus STA4 receives the MAC frame decoded by the baseband processing unit 3. The reception unit 14 analyzes the MAC header to detect based on frame control information that the frame of interest is the request to send frame, based on duration information that a frame sequence which continues up to time point t8 is scheduled, based on the reception address that the transmission destination is the wireless communication apparatus STA1, based on the transmission address that the source of this request to send frame is the wireless communication apparatus STA2, based on the requested number of streams that the data frame DATA is scheduled to be transmitted in two streams, that the demultiplexing capacity is a maximum of 2-stream multiplexing, that the frame requests the wireless communication apparatus STA1 to return a channel state, the transmission power value, and so forth.

The wireless communication apparatus STA3 also simultaneously monitors the request to send frame MU-RTS1. Since the operation of the wireless communication apparatus STA3 is basically the same as the wireless communication apparatus STA4, a detailed description thereof will not be repeated.

During an interval between time points t3 and t4, the wireless communication apparatus STA4 receives a clear to send frame MU-CTS1 transmitted by the wireless communication apparatus STA1. Since the reception processing by the wireless communication apparatus STA4 is essentially the same as that of the aforementioned request to send frame MU-RTS1, a detailed description thereof will not be repeated. Assume that the reception processing is completed before time point t5.

The wireless communication apparatus STA4 obtains the following pieces of information at time point t5. The reasons why these pieces of information are obtained will be appended in correspondence to the information.

(I1) The wireless communication apparatus STA2 is scheduled to transmit the data frame DATA1 including the maximum number of streams=2 to the wireless communication apparatus STA1 in a duration between time points t5 and t6.

(Reason) Since the transmission request of the request to send frame MU-RTS1 is permitted by the clear to send frame MU-CTS1, a communication with the permitted contents will occur from now. The maximum number of streams can be detected based on the permitted number of streams in the frame MU-CTS1. It can be detected based on information associated with a duration included in the frame MU-CTS1 that a frame sequence is scheduled to end at time point t8. Assume that this frame sequence is a simple sequence, i.e., the data frame—the acknowledgement frame (when a more complicated frame sequence is to be permitted, for example, more detailed information associated with a duration may be included). Also, assume that since the acknowledgement frame has a fixed length, and the modulation scheme, coding scheme, and the like required to transmit this frame are determined in advance based on a certain rule, a period of time required to transmit the acknowledgement frame can be calculated (when the modulation scheme and coding scheme of the acknowledgement frame is determined based on those of the preceding data frame, this calculation is made after the physical layer header 21 of the data frame DATA1 is received). Assume that a time interval between the data frame and acknowledgement frame is fixed to the SIFS. Time t6 can be calculated by subtracting the period of time required to transmit the acknowledgement frame BA1 and the SIFS time period from time point t8. The number of streams acquisition/estimation unit 17 executes this processing and stores the result.

(I2) The wireless communication apparatus STA1 is scheduled to transmit the acknowledgement frame BA1 including the maximum number of streams=2 to the wireless communication apparatus STA2 in a duration between time points t7 and t8.

(Reason) Time t7 can be calculated by subtracting a period of time required to transmit the acknowledgement frame BA1 from time point t8. The number of streams acquisition/estimation unit 17 executes this processing and stores the result.

(I3) The multiplexing/demultiplexing capacity of the wireless communication apparatus STAT is a maximum of 2-stream multiplexing.

(Reason) This multiplexing/demultiplexing capacity can be detected from the multiplexing capacity indicated by the clear to send frame MU-CTS1. The stream demultiplexing capacity acquisition/estimation unit 16 executes this processing and stores the result.

(I4) The multiplexing/demultiplexing capacity of the wireless communication apparatus STA2 is a maximum of 2-stream multiplexing.

(Reason) This multiplexing/demultiplexing capacity can be detected from the multiplexing capacity indicated by the request to send frame MU-RTS1. The stream demultiplexing capacity acquisition/estimation unit 16 executes this processing and stores the result.

(I5) The multiplexing/demultiplexing capacity of the wireless communication apparatus (self apparatus) STA4 is a maximum of 4-stream multiplexing.

(Reason) Since this multiplexing/demultiplexing capacity is that of the self apparatus, it is registered in advance in the apparatus. The stream demultiplexing capacity acquisition/estimation unit 16 stores this capacity.

(I6) A channel state and channel loss between the wireless communication apparatuses STA1 and STA2.

(Reason) The channel state can be detected from the channel information indicated by the clear to send frame MU-CTS1. By comparing the transmission power of the request to send frame MU-RTS1 with the received power of the clear to send frame MU-CTS1, the channel loss can be detected. The transmission unit 13 of the media access control unit 4 stores this result.

(I7) A channel state and channel loss between the wireless communication apparatus STA1 and wireless communication apparatus (self apparatus) STA4.

(Reason) The wireless communication apparatus STA4 can estimate the channel state from the preamble of the clear to send frame MU-CTS1 from the wireless communication apparatus STA1. By comparing the transmission power of the clear to send frame MU-CTS1 from the wireless communication apparatus STA1 with the received power upon reception by the wireless communication apparatus STA4 (measured by the received power measurement unit 8), the channel loss can be detected. The transmission unit 13 of the media access control unit 4 stores this result.

(I8) A channel state and channel loss between the wireless communication apparatus STA2 and wireless communication apparatus (self apparatus) STA4.

(Reason) The wireless communication apparatus STA4 can estimate the channel state from the preamble of the clear to send frame MU-CTS1 from the wireless communication apparatus STA1. By comparing the transmission power of the clear to send frame MU-CTS1 from the wireless communication apparatus STA1 with the received power upon reception by the wireless communication apparatus STA4 (measured by the received power measurement unit 8), the channel loss can be detected. The transmission unit 13 of the media access control unit 4 stores this result.

(I9) The allowable number of streams in a duration between time points t5 and t6 is a maximum of two streams. However, it is premised on that the spatial multiplexing/demultiplexing unit 11 is controlled so as not to interfere with the wireless communication apparatus STA1 at the time of transmission. Also, it is premised on that the spatial multiplexing/demultiplexing unit 11 is controlled to cancel any interference from the wireless communication apparatus STA2 upon reception of a response.

(Reason) As can be seen from the pieces of information (I1) and (I5) above, the spatial multiplexing/demultiplexing unit 11 of the wireless communication apparatus (self apparatus) STA4 controls not to interfere with a communication from time point t5 to time point t6, and then leaves two degrees of freedom for transmission/reception of itself. When the wireless communication apparatus (self apparatus) STA4 performs transmission, if it interferes with the wireless communication apparatus STA2 whose transmission is underway, no problem is posed, and the degrees of freedom of the spatial multiplexing/demultiplexing unit 11 are not decreased for this purpose. However, since the wireless communication apparatus STA4 has to suppress an interference with the wireless communication apparatus STA1 whose reception is underway, two degrees of freedom of the spatial multiplexing/demultiplexing unit 11 are required for this purpose. On the other hand, when the wireless communication apparatus (self apparatus) STA4 performs reception, two degrees of freedom of the spatial multiplexing/demultiplexing unit 11 are required to cancel two streams transmitted by the wireless communication apparatus STA2 as an interference. From the pieces of information (I3) and (I5) above, since no degree of freedom is left to cancel any interference on the side of the wireless communication apparatuses STA1 and STA2, only two degrees of freedom left in the spatial multiplexing/demultiplexing unit 11 of the wireless communication apparatus (self apparatus) STA4 can be consequently used to cancel an interference. For this reason, as can be seen from the above description, the allowable number of streams is a maximum of two streams. The allowable number of streams calculation/storage unit 18 makes this calculation and stores the result.

(I10) The allowable number of streams in a duration between time points t6 and t7 is a maximum of four streams.

(Reason) From the pieces of information (I1) and (I2) above, it is calculated that the duration between time points t6 and t7 is an SIFS frame time interval, and no frame transmission is made. The allowable number of streams calculation/storage unit 18 makes this calculation and stores the result.

(I11) The allowable number of streams in a duration between time points t7 and t8 is a maximum of two streams. However, it is premised on that the spatial multiplexing/demultiplexing unit 11 is controlled so as not to interfere with the wireless communication apparatus STA1 at the time of transmission. Also, it is premised on that the spatial multiplexing/demultiplexing unit 11 is controlled to cancel any interference from the wireless communication apparatus STA1 upon reception of a response.

(Reason) The same calculation as in (I9) is made. The allowable number of streams calculation/storage unit 18 makes this calculation and stores the result.

At time point t5, the wireless communication apparatus STA4 controls the spatial multiplexing/demultiplexing unit 11 to cancel a signal of the data frame DATA1 transmitted by the wireless communication apparatus STA2 as an interference. This control can be attained using the channel information between the wireless communication apparatus STA2 and self apparatus, which is held by the transmission unit 13, by predicting based on the information (I1) that the wireless communication apparatus STA2 is scheduled to start a two-stream communication from time point t5. A beam to be formed in this way will be referred to as a “predicted waiting beam” hereinafter. The wireless communication apparatus STA4 receives a signal after an interference is removed by the predicted waiting beam by itself. The signal after the interference is removed may be background noise alone or a signal transmitted by an apparatus other than the wireless communication apparatus STA2. Such control is required to wait for another frame which may be transmitted from another wireless communication apparatus since it is media access control having random access characteristics. That signal is also used as an input to the physical carrier sense unit 9.

When the wireless communication apparatus STA4 begins to receive an unpredictable frame, it controls the spatial multiplexing/demultiplexing unit 11 to form a “delayed waiting beam” to cancel an interference by that frame when its channel information is revealed. The timings for forming these beams are distinguished by their names for the sake of descriptive convenience. Once the beams are formed, they function similarly. Note that both the waiting beams are formed only when the number of streams of a received frame is equal to or smaller than a maximum degree of multiplexing indicating the demultiplexing capacity of the spatial multiplexing/demultiplexing unit 11.

Assume that the wireless communication apparatus STA4 has data to be transmitted to the wireless communication apparatus STA3 at time point t5. In order to reduce the possibility of collision between this transmission and transmission from another wireless communication apparatus, the transmission unit 13 starts backoff processing. The backoff processing generates an integer random number up to a maximum value determined by a certain rule, decrements that value one by one when a medium is idle over one slot duration, and starts transmission when the value reaches zero. This value remains unchanged in a duration in which a medium is busy, and the decrement processing is restarted when the medium becomes idle later.

From time point t5, the transmission unit 13 of the wireless communication apparatus STA4 continuously inquires the virtual carrier sense unit 15 for an idle/busy status of a medium so as to implement the backoff processing. The carrier state determination unit 19 of the virtual carrier sense unit 15 further inquires the physical carrier sense unit 9 for a state. Before the processing of the spatial multiplexing/demultiplexing unit 11, received power equal to or larger than a threshold used to determine “busy” is detected by the carrier sense. However, upon reception using the predicted waiting beam, it is notified that received power is equal to or smaller than the threshold. Then, the carrier state determination unit 19 can estimate that only a communication predicted based on (I1) is made. That is, the carrier state determination unit 19 determines that the medium is idle. Furthermore, the carrier state determination unit 19 refers to the information of the allowable number of streams calculation/storage unit 18 and notifies that a medium for a maximum of two streams is continuously idle until time point t8 as long as a forward interference to the wireless communication apparatus STA1 is suppressed at the time of transmission, and an interference from the wireless communication apparatus STA2 is removed at the time of reception. However, a condition indicating that different processing associated with interference suppression is executed in a duration between time points t5 and t6 and in that between time points t7 and t8 is added. In order to prevent the processing from being unnecessarily complicated, the fact that the maximum number of streams is four from time point t6 to time point t7 is ignored.

Assume that the backoff processing started from time point t5 is completed at time point s1. The transmission unit 13 of the media access control unit 4 of the wireless communication apparatus STA4 transmits a request to send frame MU-RTS2 to the wireless communication apparatus STA3. The transmission unit 13 controls the spatial multiplexing/demultiplexing unit 11 using the channel information between the wireless communication apparatus (self apparatus) STA4 and the wireless communication apparatus STA1, so that this frame does not interfere with the wireless communication apparatus STA1. Furthermore, the transmission power may be controlled to further reduce an interference with the wireless communication apparatus STA1 in consideration of the channel loss information, if necessary.

The baseband processing unit 3 sets a frame length, modulation scheme, and coding scheme of the physical layer header 21 of this frame in accordance with a request from the transmission unit 13 of the media access control unit 4. The end time of this frame is time point s2.

The transmission unit 13 in the media access control unit 4 of the wireless communication apparatus STA4 configures the request to send frame MU-RTS2 as follows. A frame control field includes information indicating that this MAC frame is a request to send frame. In a duration field, a value obtained by subtracting time point s2 from time point s7 is set. In this case, time point s7 is ahead of time point t8, and is set in consideration that a medium for two streams is scheduled to be continuously idle until time t8.

Note that the length of a data frame DATA2 which is scheduled to transmit is determined to satisfy this restriction. The address of the wireless communication apparatus STA3 is set in a reception address field, and that of the wireless communication apparatus (self apparatus) STA4 is set in a transmission address field. For the reason described above, the requested number of streams is 2. A demultiplexing capacity field is set with a maximum of 4-stream multiplexing. Also, information that requests the wireless communication apparatus STA3 to return a channel state is set.

Information of transmission power upon transmitting this frame is set. A CRC value is calculated for the entire MAC frame, and is set in the FCS 24.

When the demultiplexing capacity of the wireless communication apparatus STA3 is smaller than a maximum of 4-stream multiplexing as an assumption in this case, the operation is changed accordingly. When the demultiplexing capacity of the wireless communication apparatus STA3 is a maximum of 3-stream multiplexing, the requested number of streams has to be decreased to 1, and the request to send frame MU-RTS2 has to be transmitted using one stream. When the demultiplexing capacity of the wireless communication apparatus STA3 is a maximum of 2-stream multiplexing, since a mutual communication with the wireless communication apparatus STA3 cannot be made in a duration between time points t5 and t8 due to an insufficient interference removal capacity, the request to send frame MU-RTS2 is not transmitted.

Note that when the wireless communication apparatus STA4 does not have any information associated with the demultiplexing capacity of the wireless communication apparatus STA3, it may transmit the request to send frame MU-RTS2 under the assumption that the demultiplexing capacity is a maximum of 4- or 3-stream multiplexing.

At the time point t5, the wireless communication apparatus STA3 obtains pieces of information equivalent to the pieces of information (I1) to (I11) above, and forms a predicted waiting beam according to them. Using the predicted waiting beam, the wireless communication apparatus STA3 can cancel the data frame DATA1 which is being parallelly transmitted by the wireless communication apparatus STA2 ahead of the frame to be received as an interference signal, and can demultiplex and receive only the request to send frame MU-RTS2.

Upon reception of the request to send frame MU-RTS2, the wireless communication apparatus STA3 obtains pieces of information equivalent to the pieces of information (I1) to (I11) above. The reception unit 14 sends an inquiry to the virtual carrier sense unit 15, and draws a conclusion that no problem is posed if the requested transmission is permitted. Based on this conclusion, the wireless communication apparatus STA3 transmits a clear to send frame MU-CTS2 that permits the requested transmission to the wireless communication apparatus STA4. The transmission unit 13 controls the spatial multiplexing/demultiplexing unit 11 using the channel information between the wireless communication apparatus (self apparatus) STA3 and the wireless communication apparatus STA1, so that this frame does not interfere with the wireless communication apparatus STA1. Furthermore, the transmission power may be controlled to further reduce an interference with the wireless communication apparatus STA1 in consideration of the channel loss information, if necessary.

The transmission unit 13 in the media access control unit 4 of the wireless communication apparatus STA3 configures the clear to send frame MU-CTS2 as follows. A frame control field includes information indicating that this MAC frame is a clear to send frame. In a duration field, a value obtained by subtracting time point s4 from time point s7 is set. In this case, time point s7 is calculated from the duration of the request to send frame MU-RTS2, and the duration to be permitted is set in consideration that time point s7 is ahead of time point t8 but a medium for two streams is scheduled to be continuously idle until time point t8. The address of the wireless communication apparatus STA4 is set in a reception address field, and that of the wireless communication apparatus (self apparatus) STA3 is set in a transmission address field. For the reason described above, the permitted number of streams is 2. A demultiplexing capacity field is set with a maximum of 4-stream multiplexing. Also, the channel information between the wireless communication apparatus STA4 and the wireless communication apparatus (self apparatus) STA3, which is obtained from the channel estimation unit 10, is set. Information of transmission power upon transmitting this frame, and the received power of the request to send frame MU-RTS2, which is obtained from the received power measurement unit 8, are set. A CRC value is calculated for the entire MAC frame, and is set in the FCS 24.

Note that if the capacity of the spatial multiplexing/demultiplexing unit 11 of the wireless communication apparatus STA3 is not a maximum of 4-stream multiplexing assumed so far but it is a maximum of 3-stream multiplexing, the permitted number of streams is 1. However, this frame can be returned only when the request to send frame MU-RTS2 is sent using one stream in place of two streams. This is because, in order to receive the frame MU-RTS2 transmitted using two streams by the predicted waiting beam, the demultiplexing capacity of a maximum of 4-stream multiplexing is required, and that frame cannot be received by the demultiplexing capacity of a maximum of 3-stream multiplexing. If the capacity of the spatial multiplexing/demultiplexing unit 11 of the wireless communication apparatus STA3 is a maximum of 2-stream multiplexing, since a predicted waiting beam cannot be configured, the request to send frame MU-RTS2 cannot be received, and the clear to send frame MU-CTS2 cannot be transmitted, either.

Using the predicted waiting beam, the wireless communication apparatus STA4 cancels the data frame DATA1 which is being parallelly transmitted by the wireless communication apparatus STA2 ahead of the frame to be received as an interference signal, and demultiplexes and receives the clear to send frame MU-CTS2.

Since the requested transmission is permitted, the transmission unit 13 in the media access control unit 4 of the wireless communication apparatus STA4 transmits a data frame DATA2 to the wireless communication apparatus STA3. The transmission unit 13 controls the spatial multiplexing/demultiplexing unit 11 using the channel information between the wireless communication apparatus (self apparatus) STA4 and the wireless communication apparatus STA1, so that this frame does not interfere with the wireless communication apparatus STA1. Furthermore, the transmission power may be controlled to further reduce an interference with the wireless communication apparatus STA1 in consideration of the channel loss information, if necessary.

The transmission unit 13 in the media access control unit 4 of the wireless communication apparatus STA4 configures the data frame DATA2 as follows. Assume that the data frame DATA2 is a data frame, which is expanded, as shown in FIG. 5, in place of the format specified in the conventional IEEE802.11n. A frame control field includes information indicating that this MAC frame is a data frame (or that which is expanded, as shown in FIG. 5). In a duration field, a value obtained by subtracting time point s5 from time point s7 is set. The address of the wireless communication apparatus STA3 is set in a reception address field, and that of the wireless communication apparatus (self apparatus) STA4 is set in a transmission address field. For the reason described above, the number of streams is two. A demultiplexing capacity field is set with a maximum of 4-stream multiplexing. Also, the channel information between the wireless communication apparatus (self apparatus) STA4 and the wireless communication apparatus STA3, which is obtained from the channel estimation unit 10 is set. Information of the transmission power upon transmitting this frame, and the received power of the clear to send frame MU-CTS2 obtained from the received power measurement unit 8 are set. Data to be transmitted, which is input from the upper link layer unit 5, is set in a data field. A CRC value is calculated for the entire MAC frame, and this value is set in the FCS 24.

Note that the frame DATA2 may be a data frame which is specified by the conventional IEEE802.11n or the like, and includes no expansion according to the present invention. However, when the frame structure specified in FIG. 5 is used, another wireless communication apparatus can be informed of pieces of information such as the number of streams, demultiplexing capacity, channel information, and transmission/received power. Thus, when another wireless communication apparatus (not shown) further parallelly makes a communication, it can use these pieces of information. Upon completion of the communication between the wireless communication apparatuses STA3 and STA4 in this embodiment, respective wireless communication apparatuses (including those except for the apparatuses STA3 and STA4) can make parallel communications using these pieces of information.

Using the predicted waiting beam, the wireless communication apparatus STA3 cancels the data frame DATA1 which is being parallelly transmitted by the wireless communication apparatus STA2 ahead of the frame to be received as an interference signal, and demultiplexes and receives the data frame DATA2.

The wireless communication apparatus STA3 configures an acknowledgement frame BA2 according to the reception status of the data frame DATA2, and transmits it to the wireless communication apparatus STA4. That is, a CRC value of the data frame DATA2 is calculated to confirm if the calculated CRC value matches the FCS 24, i.e., to determine if the data frame DATA2 can be successfully received, and that result is reflected in acknowledgement information of the acknowledgement frame BA2. Note that the data frame DATA2 may include a plurality of re-send units like A-MPDU specified by the IEEE802.11n. In such case, CRC values appended to these units are individually confirmed.

The transmission unit 13 in the media access control unit 4 of the wireless communication apparatus STA3 detects that transmission of the acknowledgement frame BA2 addressed to the wireless communication apparatus STA4 requires a duration from time point t6 to time point s7, and sends an inquiry for an idle/busy status of a medium in this duration to the virtual carrier sense unit 15. The carrier state determination unit 19 refers to the information of the allowable number of streams calculation/storage unit 18 and notifies that a medium for a maximum of two streams is continuously idle until time point t8 as long as a forward interference to the wireless communication apparatus STA2 is suppressed at the time of transmission in a duration between time points t6 and t8. In the end, as for the transmission duration between time points t6 and s7 of the acknowledgement frame BA2, forward interference suppression with respect to the wireless communication apparatus STA2 is required, and the spatial multiplexing/demultiplexing unit 11 is controlled using the channel state information between the wireless communication apparatus (self apparatus) STA3 and the wireless communication apparatus STA2, so that this frame does not interfere with the wireless communication apparatus STA2. Furthermore, the transmission power may be controlled to further reduce an interference with the wireless communication apparatus STA2 in consideration of the channel loss information, if necessary. In the conventional IEEE802.11, when an acknowledgement frame is transmitted in an SIFS (Short Inter Frame Space) immediately after reception of a data frame, confirmation of an idle/busy status is not required. Thus, confirmation of an idle/busy status may be omitted. However, even in such case, forward interference suppression control is required.

Note that it has already been predicted at the time point of returning the clear to send frame MU-CTS2 that as for the transmission duration between time points t6 and s7 of the acknowledgement frame BA2, forward interference suppression with respect to the wireless communication apparatus STA2 is required, and the spatial multiplexing/demultiplexing unit 11 has to be controlled using the channel state information between the wireless communication apparatus (self apparatus) STA3 and the wireless communication apparatus STA2, so that this frame does not interfere with the wireless communication apparatus STA2. Information indicating that the spatial multiplexing/demultiplexing unit 11 is controlled not to interfere with the apparatus STA2 upon transmission of the acknowledgement frame BA2 may be set in advance in the transmission unit 13 of the media access control unit 4, thereby reducing the processing volume (e.g., inquiry processing with respect to the virtual carrier sense unit 15) between reception of the data frame DATA2 and transmission of the acknowledgement frame BA2. In general, making a response in the SIFS requires much time in the processing of the physical layer, and the processing of the MAC layer does not have much time left. Therefore, such setting is effective to implement to immediately return the acknowledgement frame BA2.

Since the wireless communication apparatuses STA3 and STA4 execute control in this way, the communication between the wireless communication apparatuses STA1 and STA2, which was started from time point t1, ends at time point t8 without being interfered by the wireless communication apparatuses STA3 and STA4.

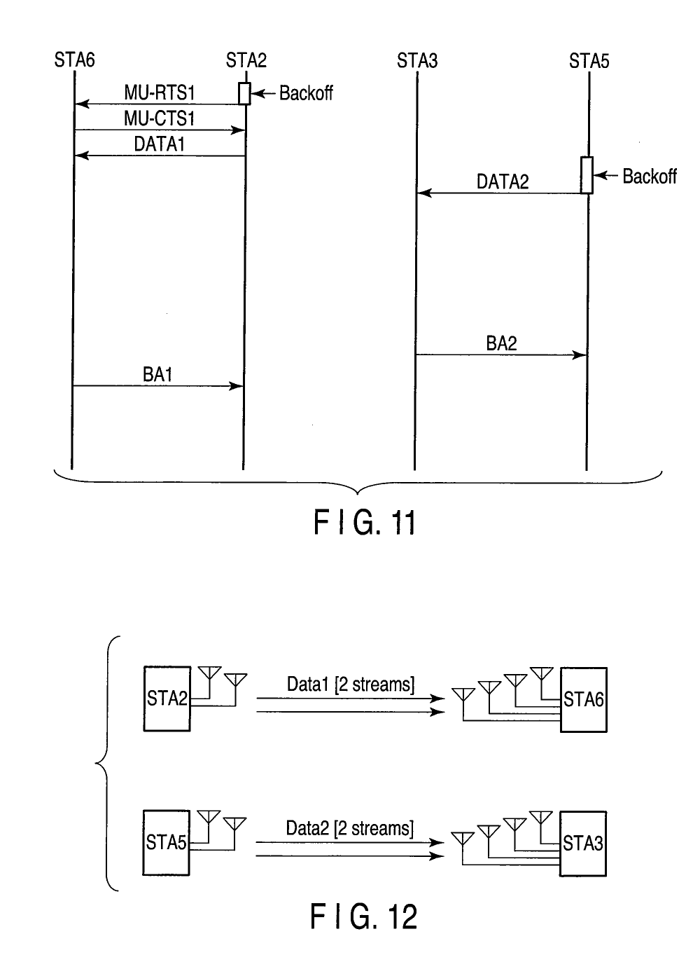

FIG. 11 shows another example of frame exchange. This example has different combinations of wireless communication apparatuses from the example of frame exchange shown in FIG. 7. Also, unlike in the example shown in FIG. 7, frames MU-RTS2 and MU-CTS2 are not exchanged before transmission of a frame DATA2.

FIG. 12 shows the combination contents of assumed wireless communication apparatuses and frame transmissions in association with the second example in which a plurality of wireless communication apparatus pairs parallelly make communications. In the first and second examples, combinations of the spatial multiplexing/demultiplexing capacities of respective wireless communication apparatuses are different. In the first example, the wireless communication apparatuses STA4 and STA3, which start a communication later, suppress a forward interference to the wireless communication apparatuses STA2 and STA1, which started a communication first, and cancel a backward interference from the wireless communication apparatuses STA2 and STA1 using their spatial multiplexing/demultiplexing capacities. The wireless communication apparatuses STA2 and STA1 are not involved in the interference suppression control.

By contrast, in the second example, the interference suppression control is executed using the spatial multiplexing/demultiplexing capacity of the wireless communication apparatus STA6 of the wireless communication apparatuses STA2 and STA6, which starts a communication first, and that of the wireless communication apparatus STA3 of the wireless communication apparatuses STA5 and STA3, which starts communication later.

An overview of the sequence will be explained here, and details of processes required in respective stages will be described later. As shown in FIG. 11, the wireless communication apparatus STA2 determines that the medium is idle, executes backoff processing, and then transmits a request to send frame MU-RTS1 (multi-user request to send) to the wireless communication apparatus STA6. When the wireless communication apparatus STA6 determines that it can receive transmission according to the requested contents, it returns a clear to send frame MU-CTS1 (multi-user clear to send) to the wireless communication apparatus STA2. The wireless communication apparatus STA2 detects that the requested transmission can be done, since it receives the frame MU-CTS1, and transmits a data frame DATA1 to the wireless communication apparatus STA6.

During transmission of the data frame DATA1, the wireless communication apparatus STA5 detects, based on information (a communication of 2-stream multiplexing) previously exchanged using the frames MU-RTS1 and MU-CTS1 and the spatial multiplexing/demultiplexing capacity (a maximum of 2-stream multiplexing) of the self wireless communication apparatus, that even when a frame up to the number of streams=2 is concurrently transmitted, the wireless communication apparatus STA6 can exclude it as an interference (or if that frame is transmitted to the wireless communication apparatus STA6, the wireless communication apparatus STA6 can demultiplex and receive that frame). Assume that the wireless communication apparatus STA5 detects that the wireless communication apparatus STA3 has a spatial multiplexing/demultiplexing capacity of 4-stream multiplexing. The wireless communication apparatus STA5 detects that even when a frame including the number of streams=2 is transmitted to the wireless communication apparatus STA3 concurrently with the above communication, the wireless communication apparatus STA3 can demultiplex and receive the frame from the wireless communication apparatus STA5 by excluding the data frame DATA1 transmitted from the wireless communication apparatus STA2 to the wireless communication apparatus STA6 as an interference.

Then, the wireless communication apparatus STA5 transmits a data frame DATA2 including the number of streams=2 to the wireless communication apparatus STA3. Unlike in FIG. 7, a request to send frame MU-RTS2 and clear to send frame MU-CTS2 are not exchanged. This is because the wireless communication apparatus STA5 detects that the frame MU-CTS2 cannot be received by demultiplexing the data frame DATA1 as an interference by its spatial multiplexing/demultiplexing capacity. The wireless communication apparatus STA6 which is receiving the data frame DATA1 demultiplexes and receives the interrupted data frame DATA2 and the data frame DATA1, respectively, using the spatial multiplexing/demultiplexing capacity. Thus, the wireless communication apparatus STA6 can detect information which is included in the data frame DATA2 and is required to control a virtual carrier sense. The wireless communication apparatus STA3, which excludes the data frame DATA1 as an interference, demultiplexes and receives the data frame DATA2 as a desired signal using the spatial multiplexing/demultiplexing capacity.

Upon completion of reception of the data frame DATA2, the wireless communication apparatus STA3 transmits an acknowledgement frame BA2 (Block Ack) having the contents according to the reception result to the wireless communication apparatus STA5. The wireless communication apparatus STA3 transmits this acknowledgement frame BA2 so as not to interfere with the wireless communication apparatus STA2, which receives a frame BA1, using its spatial multiplexing/demultiplexing capacity. Note that transmission of the frame BA2 is controlled to start after completion of transmission of the frame DATA1 and to end before completion of transmission of the frame BA1. On the premise of this control, the transmission completion time of the frame DATA2 and its duration field are set. This is required to determine whether or not to complete the scheduled parallel transmission by the given spatial multiplexing/demultiplexing capacity without causing any interference.

Upon completion of reception of the data frame DATA1, the wireless communication apparatus STA6 transmits an acknowledgement frame BA1 (Block Ack) having the contents according to the reception result to the wireless communication apparatus STA2.

The wireless communication apparatus STA6 transmits this acknowledgement frame BA1 so as not to interfere with the wireless communication apparatus STA5, which receives the frame BA2, using its spatial multiplexing/demultiplexing capacity. The reason why such control can be executed is that the wireless communication apparatus STA6 detects channel information with the wireless communication apparatus STA5 and information required for virtual carrier sense control by receiving the data frame DATA2, and detects based on the latter information that the wireless communication apparatus STA5 is receiving the acknowledgement frame BA2. The channel information is used to control the spatial multiplexing/demultiplexing capacities, as described above.

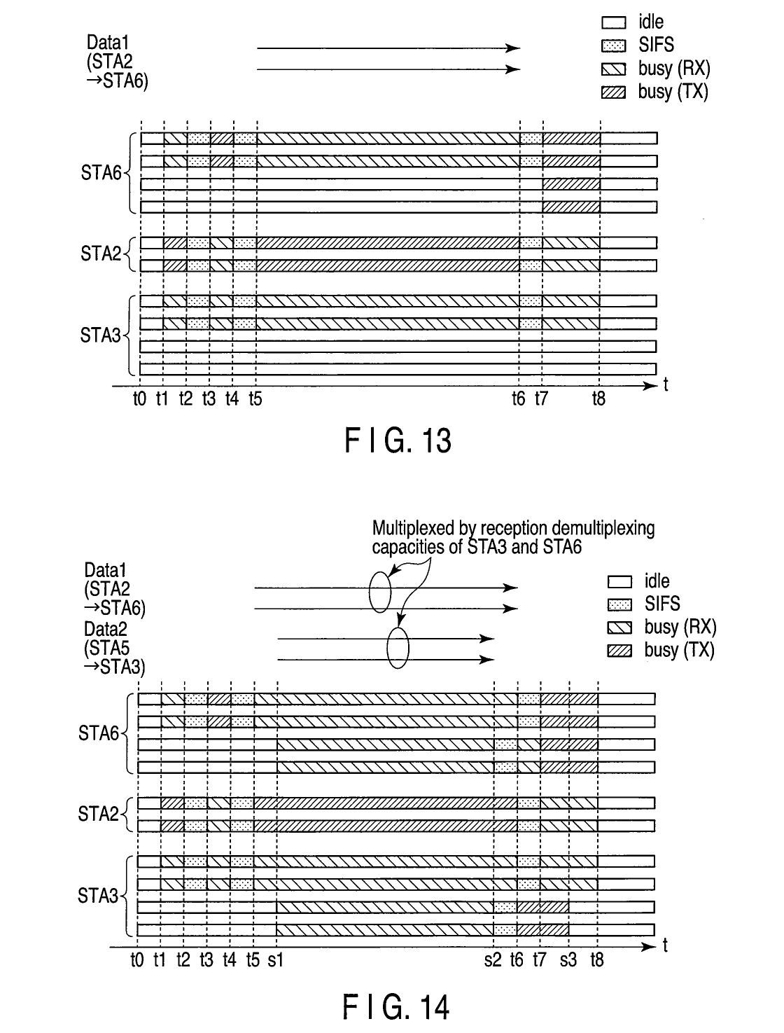

Information required for the wireless communication apparatus STA4 to make a carrier sense in case of the aforementioned operations will be described below in association with carrier sense state management (1) of the second example in which a plurality of wireless communication apparatus pairs parallelly make communications shown in FIG. 13, and carrier sense state management (2) of the second example in which a plurality of wireless communication apparatus pairs parallelly make communications shown in FIG. 14. Since the essential part of this example is the same as the first example, differences from the first example will be mainly explained below.

Pieces of information obtained by the wireless communication apparatus STA5 at time point t5 are similar to those obtained by the wireless communication apparatus STA4 at time point t5 in the first example. However, the multiplexing order of the wireless communication apparatus STA6 and that of the wireless communication apparatus (self apparatus) STA5 are different from those of the corresponding apparatuses (the apparatuses STA1 and STA4) in the first example. Accordingly, the allowable number of streams is different.

(I3-2) The multiplexing/demultiplexing capacity of the wireless communication apparatus STA6 is a maximum of 4-stream multiplexing.

(I5-2) The multiplexing/demultiplexing capacity of the wireless communication apparatus (self apparatus) STA4 is a maximum of 2-stream multiplexing.

(I9-2) The allowable number of streams to be transmitted in a duration between time points t5 and t6 is a maximum of two streams. However, it is premised on that the wireless communication apparatuses STA6 and STA3 demultiplex the data frame DATA1 and the frame of the two streams by controlling their spatial multiplexing/demultiplexing capacities. Also, the allowable number of streams to be received is zero (i.e., no reception is allowed).

(I10-2) The allowable number of streams in a duration between time points t6 and t7 is a maximum of two streams both for transmission and reception.

(I11-2) The allowable number of streams to be received in a duration between time points t7 and t8 is a maximum of two streams. In this case, it is premised on that the wireless communication apparatus STA3 is on the transmitting side, and suppresses an interference to the wireless communication apparatus STA2, which receives the acknowledgement frame BA1, by controlling its spatial multiplexing/demultiplexing capacity. However, the allowable number of streams to be transmitted is zero (i.e., no transmission is allowed).

Assume that the wireless communication apparatus STA5 has data to be transmitted to the wireless communication apparatus STA3 at time point t5. The transmission unit 13 of the wireless communication apparatus STA5 continuously inquires the virtual carrier sense unit 15 for an idle/busy status of a medium so as to implement the backoff processing. The carrier state determination unit 19 refers to the information of the allowable number of streams calculation/storage unit 18, and notifies, from the pieces of information (I9-2) and (I10-2), the wireless communication apparatus STA3 that a medium is idle until time point t7 to allow transmission of a maximum of two streams. Also, the carrier state determination unit 19 notifies that no reception is allowed in a duration until time point t6.

Assume that the backoff processing started from time point t5 is completed at time point s1. The transmission unit 13 of the media access control unit 4 of the wireless communication apparatus STA5 transmits the data frame DATA2 to the wireless communication apparatus STA3. Assume that the data frame DATA2 has the frame structure shown in FIG. 5, and respective field values are set based on the same concept as in the first example. The wireless communication apparatus STA3 receives the data frame DATA2 using a predicted waiting beam as in the first example.

Upon detection of the data frame DATA2, the wireless communication apparatus STA6, which is receiving the data frame DATA1, forms a delayed waiting beam by controlling the spatial multiplexing/demultiplexing unit 11, and demultiplexes and receives the data frames DATA1 and DATA2. The wireless communication apparatus STA6 obtains the following pieces of information from the data frame DATA2.

(I1-2′) The wireless communication apparatus STA5 is scheduled to transmit the data frame DATA2 including the number of streams=2 to the wireless communication apparatus STA3 in a duration between time points s1 and s2.

(Reason) This information can be revealed from information included in the physical layer header 21 and MAC layer header 22.

(I2-2′) The wireless communication apparatus STA3 is scheduled to transmit the acknowledgement frame BA2 including the maximum number of streams=2 to the wireless communication apparatus STA5 in a duration between time points t6 and s3.

(I3-2′) The multiplexing/demultiplexing capacity of the wireless communication apparatus STA5 is a maximum of 2-stream multiplexing.

(I4-2′) The multiplexing/demultiplexing capacity of the wireless communication apparatus STA3 is unknown but it is 4-stream multiplexing or more (estimation).

(Reason) It is estimated that at least 4-stream multiplexing is required when the wireless communication apparatus STA5 starts transmission to the wireless communication apparatus STA3 according to the virtual carrier sense rule.

(I5-2′) The multiplexing/demultiplexing capacity of the wireless communication apparatus (self apparatus) STA6 is a maximum of 4-stream multiplexing.

(I6-2′) A channel state and channel loss between the wireless communication apparatuses STA5 and STA3 are unknown.

(Reason) The request to send frame MU-RTS2 and clear to send frame MU-CTS2 are not exchanged.

(I7-2′) A channel state and channel loss between the wireless communication apparatus STA5 and wireless communication apparatus (self apparatus) STA6.

(I8-2′) A channel state and channel loss between the wireless communication apparatus STA3 and wireless communication apparatus (self apparatus) STA6 are unknown.

(I9-2′) The allowable number of streams in a duration between time points t6 and s3 is a maximum of two streams. However, it is premised on that the spatial multiplexing/demultiplexing unit 11 is controlled so as not to interfere with the wireless communication apparatus STA5 at the time of transmission. Also, it is premised on that the spatial multiplexing/demultiplexing unit 11 is controlled to cancel an interference from the wireless communication apparatus STA3 upon reception of a response.

(I10-2′) The allowable number of streams in a duration between time points s3 and t8 is a maximum of four streams.

At time point t6, the wireless communication apparatus STA3 configures the acknowledgement frame BA2 according to the reception status of the data frame DATA2, as in the first example, and transmits that frame to the wireless communication apparatus STA5 after forward interference suppression to the wireless communication apparatus STA2.

At time point t7, the wireless communication apparatus STA6 configures the acknowledgement frame BA1 according to the reception status of the data frame DATA1, and transmits that frame to the wireless communication apparatus STA2 after forward interference suppression to the wireless communication apparatus STA5. In this case, the transmission unit 13 in the media access control unit 4 of the wireless communication apparatus STA6 recognizes, based on a response from the virtual carrier sense unit 15, that forward interference suppression to the wireless communication apparatus STA5 is required. In this case, the virtual carrier sense unit 15 refers to the pieces of information (I9-2′) and (I10-2′). Also, the transmission unit 13 controls the spatial multiplexing/demultiplexing unit 11 using the information (I7-2′) to suppress an interference to the wireless communication apparatus STA5.

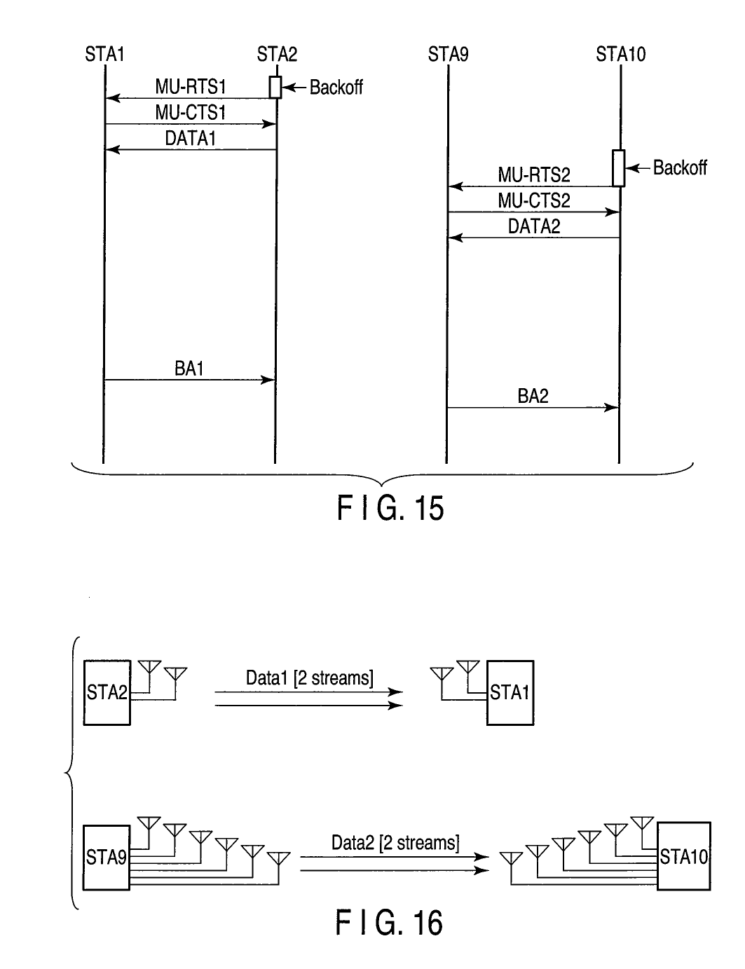

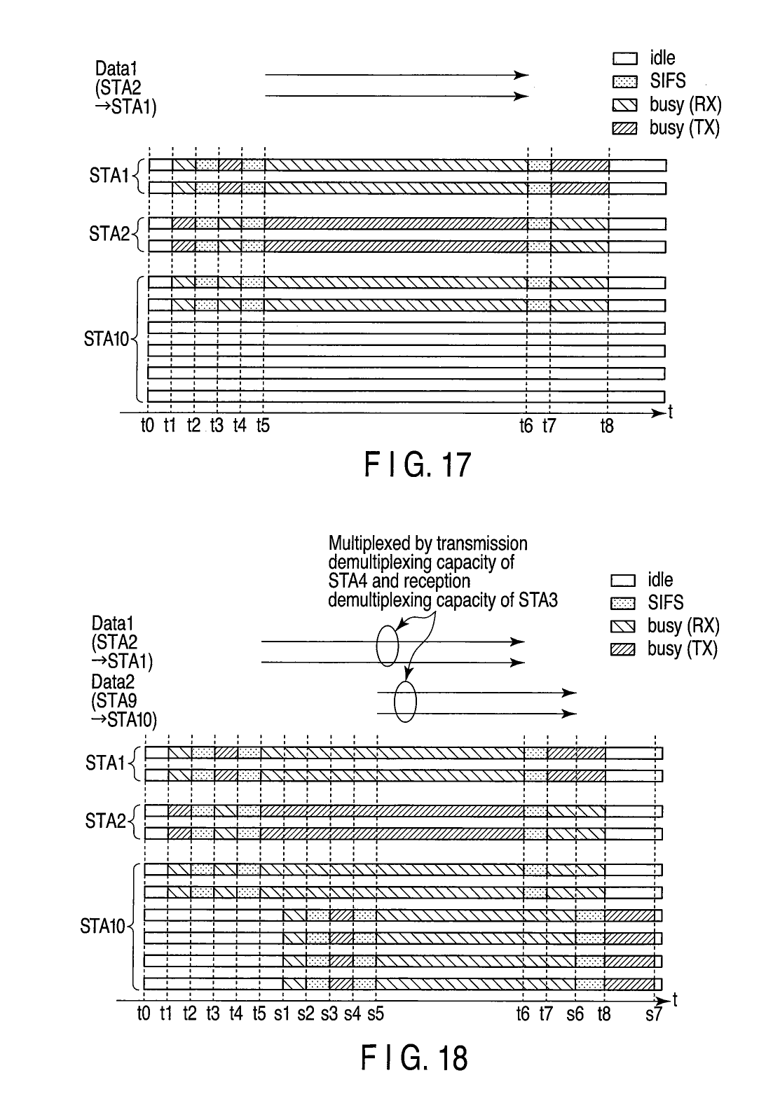

FIG. 15 shows still another example of frame exchange. This example has different combinations of wireless communication apparatuses from the example of frame exchange shown in FIG. 7. The combination contents of assumed wireless communication apparatuses and frame transmissions will be described below in association with the third example shown in FIG. 16 in which a plurality of wireless communication apparatus pairs parallelly make communications. In the first and third examples, combinations of the spatial multiplexing/demultiplexing capacities of respective wireless communication apparatuses are different. FIGS. 17 and 18 show carrier sense states of other wireless communication apparatuses, which are managed by the wireless communication apparatus STA9. The third example is different from the aforementioned first or second example in that a duration in which transmission of a frame DATA2 and that of a frame BA1 are simultaneously and parallelly made.

In the first example, the wireless communication apparatuses STA4 and STA3, which start a communication later, suppress a forward interference to the wireless communication apparatuses STA2 and STA1, which started a communication first, and cancel a backward interference from the wireless communication apparatuses STA2 and STA1 using their spatial multiplexing/demultiplexing capacities. However, in the first example, the number of wireless communication apparatuses which are to undergo forward interference suppression and backward interference cancellation is one at a maximum. In the third example, since the apparatuses STA1 and STA2 switch their transmission and reception roles during a transmission duration of the frame DATA2, the number of wireless communication apparatuses which are to undergo forward interference suppression and backward interference cancellation is two at maximum.

As shown in FIG. 15, the wireless communication apparatus STA2 determines that the medium is idle, executes backoff processing, and then transmits a request to send frame MU-RTS1 (multi-user request to send) to the wireless communication apparatus STA1. When the wireless communication apparatus STA1 determines that it can receive transmission according to the requested contents, it returns a clear to send frame MU-CTS1 (multi-user clear to send) to the wireless communication apparatus STA2. The wireless communication apparatus STA2 detects that the requested transmission can be done, since it receives the frame MU-CTS1, and transmits a data frame DATA1 to the wireless communication apparatus STA1.

During transmission of the data frame DATA1, the wireless communication apparatus STA9 detects that the self wireless communication apparatus can suppress a forward interference to the wireless communication apparatus STA1 even when it concurrently transmits a frame up to the number of streams=4 during reception of the wireless communication apparatus STA1, based on the information (a communication of 2-stream multiplexing) previously exchanged using the frames MU-RTS1 and MU-CTS1 and the spatial multiplexing/demultiplexing capacity (a maximum of 6-stream multiplexing) of the self wireless communication apparatus. Also, the wireless communication apparatus STA9 detects that the self wireless communication apparatus can suppress a forward interference to the wireless communication apparatus STA1 and that to the wireless communication apparatus STA2 even when it continuously and concurrently transmits a frame up to the number of streams=2 during reception of the wireless communication apparatus STA1 and subsequent reception of the wireless communication apparatus STA2.

On the other hand, since the communication between the wireless communication apparatuses STA1 and STA2 is made without suppressing a forward interference to other apparatuses, the wireless communication apparatuses STA9 and STA10 have to cancel a backward interference from the wireless communication apparatuses STA1 and STA2 when they made a communication. The wireless communication apparatuses STA9 and STA10 can cancel a backward interference signal up to 2-stream multiplexing while receiving a desired signal including the number of streams=4. Also, the wireless communication apparatuses STA9 and STA10 can cancel a backward interference signal up to 4-stream multiplexing while receiving a desired signal including the number of streams=2.

Assume that the wireless communication apparatus STA9 is selected to transmit a data frame DATA2 including the number of streams=2 over a duration (between time points t5 and t6 in FIG. 17) in which the wireless communication apparatus STA2 performs transmission and the wireless communication apparatus STA1 performs reception and a duration (between time points t7 and t8 in FIG. 18) in which the wireless communication apparatus STA1 performs transmission and the wireless communication apparatus STA2 performs reception. In this case, it is premised on that the wireless communication apparatus STA10 which receives the data frame DATA2 cancels a backward interference signal of a total of 4-stream multiplexing, i.e., the data frame DATA1 transmitted by the wireless communication apparatus STA2 and an acknowledgement frame BA1 transmitted by the apparatus STA1. Based on this selection, the wireless communication apparatus STA9 transmits a request to send frame MU-RTS2, which requests to transmit a data frame DATA2 including the number of streams=2 in a duration between time points s5 and s6, in a duration between time points s1 and s2. In this case, the request to send frame MU-RTS2 is transmitted to suppress a forward interference to the wireless communication apparatus STA1, which is receiving the data frame DATA1.

In this case, it is premised on that beams are not switched during reception of the frame DATA2. If beams are appropriately switched, it is possible to receive a desired signal of 4-stream multiplexing in principle. However, since the beams have to be instantaneously switched at appropriate timings, such implementation may be difficult to attain.

Also, in another possible selection, the frame DATA2 may be ended by the number of streams=4 before the transmission and reception sides of the wireless communication apparatuses STA1 and STA2 are switched. This selection is essentially the same as the first example, although the number of streams is increased.

Note that when the wireless communication apparatus STA9 does not have any information for the demultiplexing capacity of the wireless communication apparatus STA10, it may transmit the request to send frame MU-RTS2 under the assumption that the demultiplexing capacity is a maximum of 6- or 5-stream multiplexing.

At the time point t5, the wireless communication apparatus STA10 configures a predicted waiting beam based on the information previously exchanged by the request to send frame MU-RTS1 and clear to send frame MU-CTS1. Using the predicted waiting beam, the wireless communication apparatus STA10 can cancel the data frame DATA1 which is being parallelly transmitted by the wireless communication apparatus STA2 ahead of the frame to be received as an interference signal, and can demultiplex and receive only the request to send frame MU-RTS2.

Upon reception of the request to send frame MU-RTS2, the wireless communication apparatus STA10 detects that the self apparatus can cancel a backward interference signal of a total of 4-stream multiplexing from the wireless communication apparatuses STA1 and STA2 while receiving the data frame DATA2 including the number of streams=2, based on information (a communication of 2-stream multiplexing) previously exchanged by the request to send frame MU-RTS1 and clear to send frame MU-CTS1 and the spatial multiplexing/demultiplexing capacity (a maximum of 6-stream multiplexing) of the self wireless communication apparatus. Then, the wireless communication apparatus STA10 returns a clear to send frame MU-CTS2 which permits the requested transmission to the wireless communication apparatus STA9 in a duration between time points s3 and s4. In this case, the clear to send frame MU-CTS2 is transmitted to suppress a forward interference to the wireless communication apparatus STA1 which is receiving the data frame DATA'.

Upon reception of the clear to send frame MU-CTS2, the wireless communication apparatus STA9 transmits the data frame DATA2 to the wireless communication apparatus STA10 in a duration between time points s5 and s6. In this case, the data frame DATA2 is transmitted to suppress forward interferences to the wireless communication apparatus STA1 which is receiving the data frame DATA1 and the wireless communication apparatus STA2 which is scheduled to receive the acknowledgement frame BA1 in a duration between time points t7 and t8.

Upon completion of reception of the data frame DATA2, the wireless communication apparatus STA10 transmits an acknowledgement frame BA2 (Block Ack) including the contents according to the reception result to the wireless communication apparatus STA9 in a duration between time points t8 and s7. In this case, since a schedule to make concurrent communications in the duration between time points t8 and s7 is not detected, the acknowledgement frame BA2 may be transmitted regardless of a forward interference to other wireless communication apparatuses. Alternatively, in consideration of the possibility of slight concurrent communications due to, e.g., clock errors around time point t8, the acknowledgement frame BA2 may be transmitted to suppress a forward interference to the wireless communication apparatus STA2, which is scheduled to receive the acknowledgement frame BA1 in a duration between time points t7 and t8, for the sake of safety.

Wireless communication apparatuses compliant with the existing wireless LAN standards such as IEEE802.11a, IEEE802.11b, IEEE802.11g, and IEEE802.11n have already prevailed, and it is important that the wireless communication apparatus according to the embodiment of the present invention and the conventional wireless communication apparatus can coexist and be connected to each other using an identical frequency channel.

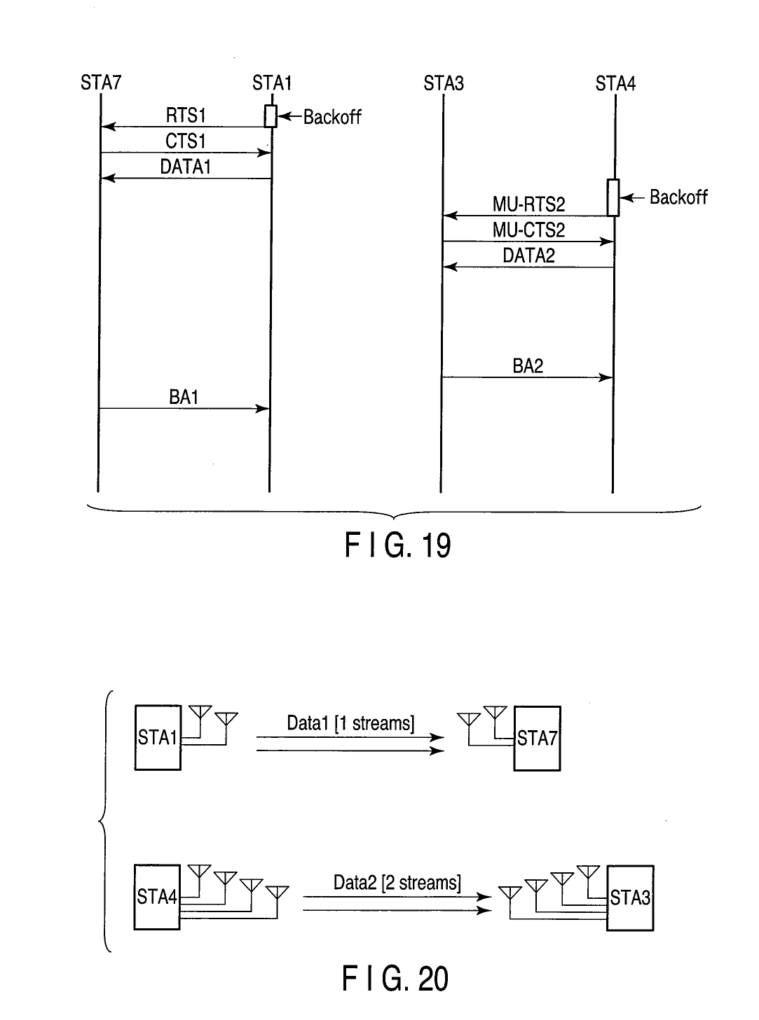

FIG. 19 shows an example of frame exchange to be discussed below. Assume that the wireless communication apparatus STA7 is that compliant with the conventional wireless LAN standard, and the wireless communication apparatuses STA1, STA3, and STA4 are those according to the embodiment of the present invention. This example is different from the aforementioned embodiments in that the wireless communication apparatus STA7 compliant with the conventional wireless LAN standard is mixed. The combination contents of assumed wireless communication apparatuses and frame transmissions will be described below in association with the fourth example in which a plurality of wireless communication apparatus pairs including a conventional apparatus parallelly make communications with reference to FIG. 20. Since the wireless communication apparatus STA7 compliant with the conventional wireless LAN standard never independently starts concurrent communications described in the present invention, a communication based on the conventional wireless LAN standard precedes temporally in this example.

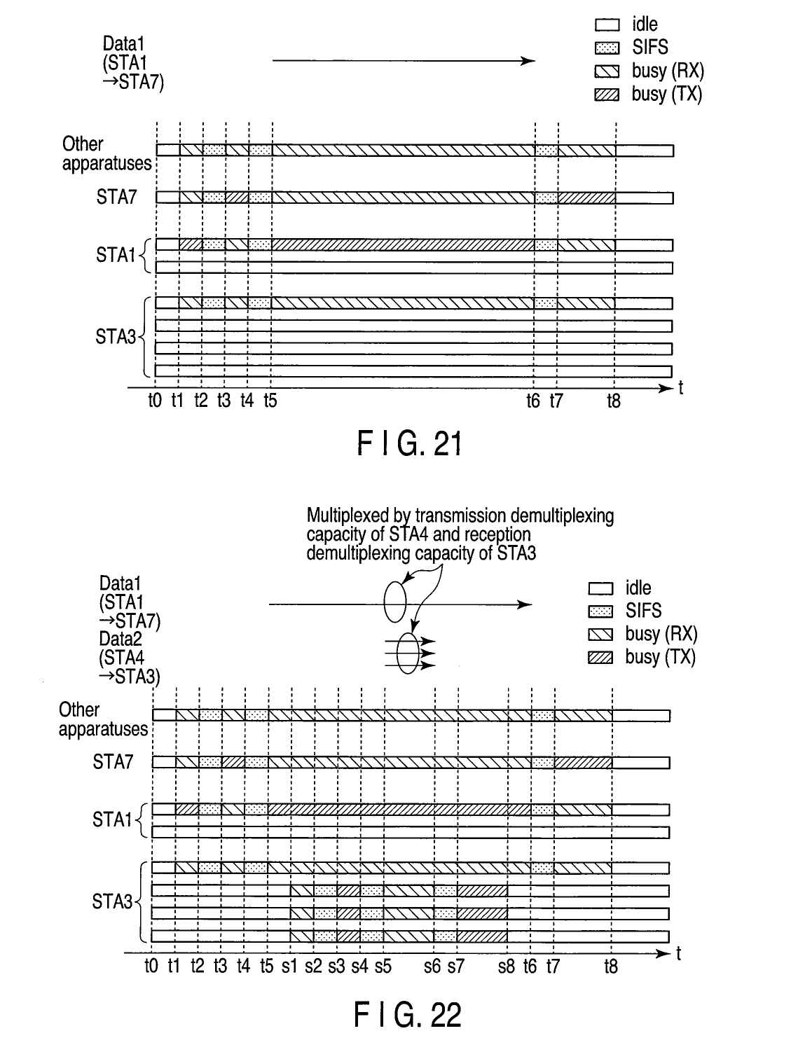

FIGS. 21 and 22 show carrier sense states of other wireless communication apparatuses, which are managed by the wireless communication apparatus STA4. Different items due to a mixed environment of the wireless communication apparatus STA7 compliant with the conventional wireless LAN standard will be described below. Assume that the conventional wireless communication apparatus STA7 is that which is compliant with IEEE802.11a, and can transmit and receive a maximum of one spatial multiplexed stream.

Since the wireless communication apparatus STA7 operates based on the existing IEEE802.11a standard, it does not make a carrier sense in consideration of the spatial division multiplex access according to the embodiment of the present invention, and manages a wireless channel medium of a certain frequency in a single carrier sense state. Thus, FIG. 21 shows only one line corresponding to the apparatus STA7, and busy (TX), busy (RX), idle, and SIFS states are integrally managed without demultiplexing a stream. On the other hand, in the wireless communication apparatuses STA1 and STA3 and the wireless communication apparatus STA4 which is not shown since it is the self apparatus, according to the embodiment of the present invention, since a carrier sense is made in consideration of the spatial division multiplex access, respective streams are demultiplexed and managed, and one line indicates “busy (RX)” during reception of one stream transmitted by the wireless communication apparatus STA7. Even when a plurality of conventional wireless communication apparatuses (not shown) compliant with the existing IEEE802.11 standard are included in addition to the wireless communication apparatus STA7, since each of these apparatuses manages a wireless channel medium of a certain channel in a single carrier sense state, their carrier sense state is represented by a line “other apparatuses”.

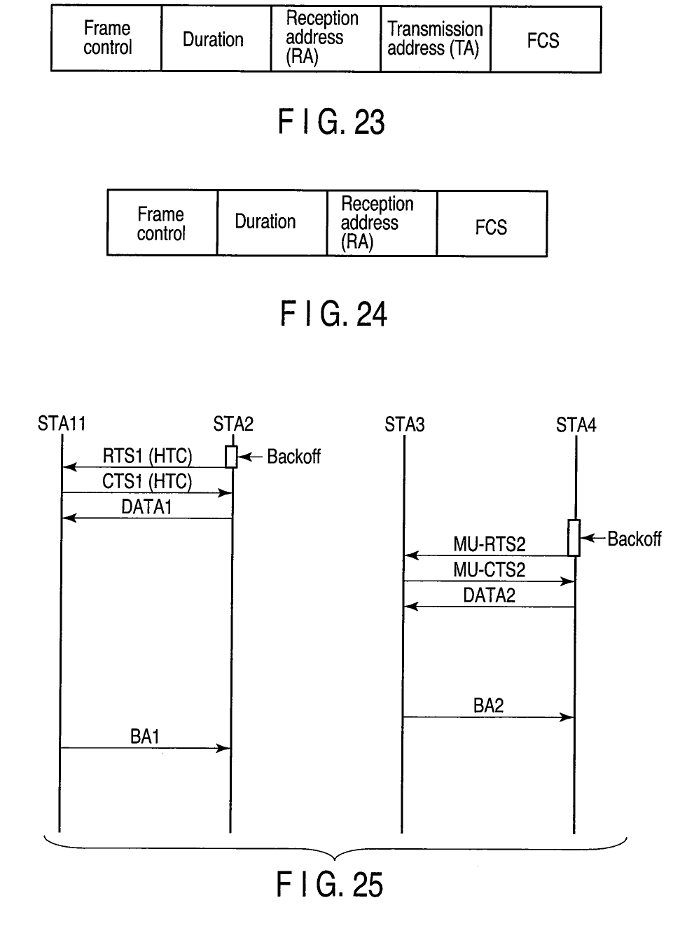

During an interval of an initial state between time points t0 and t1, assume that none of the wireless communication apparatuses STA1 to STA11 perform transmission, and a medium is unconditionally idle when viewed from all the wireless communication apparatuses. When a backoff counter is decremented during this interval and reaches zero (t1), the wireless communication apparatus STA1 begins to transmit a request to send frame RTS1 of the conventional format, which requests to transmit a data frame DATA1 that requires a duration of t6-t5 seconds, to the wireless communication apparatus STA7. At time point t2, the transmission of the frame RTS1 ends. FIG. 23 shows an example of the configuration of the request to send frame of the conventional format (specified by the IEEE802.11). Compared to the example of the configuration of the request to send frame according to the embodiment of the present invention shown in FIG. 3, the request to send frame RTS1 of the conventional format does not include information of the requested number of streams, demultiplexing capacity, channel state request, and transmission power.

The wireless communication apparatus STAT determines that the medium is idle and it can receive a transmission request of the data frame DATA1, and begins to transmit a clear to send frame CTS1 to the wireless communication apparatus STA1 at time point t3 after an elapse of an SIFS (Shortest Inter Frame Space). The transmission of the frame CTS1 ends at time point t4. FIG. 24 shows an example of the configuration of the clear to send frame of the conventional format (specified by the IEEE802.11). Compared to the example of the configuration of the clear to send frame according to the embodiment of the present invention shown in FIG. 4, the clear to send frame CTS1 of the conventional format does not include information of a transmission address, the permitted number of streams, demultiplexing capacity, channel state information, and transmission/received power.

The request to send frame RTS1 does not include information of the requested number of streams, and the clear to send frame CTS1 does not include information of the permitted number of streams. However, controlling to transmit the frame DATA1 within a range of the number of streams that can be received by the wireless communication apparatus STA7 lies in the responsibility of the wireless communication apparatus STA1. The wireless communication apparatus STA1 can detect the capacity of the wireless communication apparatus STA7 based on the contents of a management frame exchanged, e.g., at the time of association, and can attain the aforementioned control using this information.

The wireless communication apparatus STA4 monitors the request to send frame RTS1. The received power measurement unit 8 of the wireless transmission/reception unit measures received power to control the gain of the low noise amplifier, and sends information to the physical carrier sense unit 9 to determine a carrier idle/busy status. In order to use this information as that required to estimate a degree of interference to the wireless communication apparatus STA1 when the wireless communication apparatus STA4 performs transmission, that information is stored in the transmission unit 13 in the media access control unit 4. However, an associating process between this information and the wireless communication apparatus STA1 as a transmission source is completed after a MAC frame is decoded later. Associating processes between the wireless communication apparatus STA1 and various kinds of information will be completed at similar time point as above although they are not especially described.

The baseband processing unit 3 of the wireless communication apparatus STA4 executes required synchronization processing. Furthermore, the channel estimation unit 10 of the wireless communication apparatus STA4 estimates channel information with the wireless communication apparatus STA1 using a preamble of the request to send frame RTS1. This information is used to decode a physical layer header and MAC frame. On the other hand, in the first example shown in FIG. 8, this information is stored as that used to control the spatial multiplexing/demultiplexing unit 11 so that a frame transmitted by the wireless communication apparatus STA4 does not interfere with the wireless communication apparatus STA1. However, the first example shown in FIG. 8 is premised on that the preamble is appended to have a configuration that provides information associated with all antennas of the wireless communication apparatus STA1. However, in this example, assume that the request to send frame RTS1 is transmitted to have a physical frame format, which can be received by a wireless communication apparatus according to the IEEE802.11 standard such as IEEE802.11a, IEEE802.11b, or IEEE802.11g before introduction of the MIMO, and its preamble is appended not to have a configuration that provides information of channels associated with all (two) antennas of the wireless communication apparatus STA1. This is a measure required to be taken for coexistence with a wireless communication apparatus according to the IEEE802.11 such as IEEE802.11a, IEEE802.11b, or IEEE802.11g before introduction of the MIMO.

The baseband processing unit 3 of the wireless communication apparatus STA4 demodulates the physical layer header. Pieces of information of a modulation scheme, coding scheme, and frame length included in the physical layer header are used to decode the MAC frame, and are also sent to the physical carrier sense unit 9. The physical carrier sense unit 9 calculates a data rate based on the modulation scheme and coding scheme, and calculates a duration time of a frame based on this data rate and the frame length. As a result, it can be determined that a medium for one stream is busy in a duration between time points t1 and t2.

Since it is assumed in this case that the request to send frame RTS1 is transmitted to have a physical frame format, which can be received by a wireless communication apparatus according to the IEEE802.11 standard such as IEEE802.11a, IEEE802.11b, or IEEE802.11g before introduction of the MIMO, the number of transmission streams is limited to one.

The physical carrier sense unit 9 of the wireless communication apparatus STA4 sends up information associated with received power and information indicating that the medium for one stream is busy in a duration between time points t1 and t2 to the virtual carrier sense unit 15 in the media access control unit 4. At this time point, the stream demultiplexing capacity acquisition/estimation unit 16 does not have any information associated with the wireless communication apparatus STA1, and has only information associated with the self apparatus STA4 (a maximum of 4-stream multiplexing/demultiplexing). The number of streams acquisition/estimation unit 17 has information indicating that one stream is occupied in the duration between time points t1 and t2. However, since the MAC frame is not decoded yet, the number of streams acquisition/estimation unit 17 does not detect at this time point that this stream is transmitted from the wireless communication apparatus STA1 to the wireless communication apparatus STA7. If it is not detected that no interference has to be yielded to the wireless communication apparatus STA7 as a destination, a forward interference to the wireless communication apparatus STA7 cannot be suppressed by controlling the spatial multiplexing/demultiplexing unit 11 upon making transmission. Therefore, the allowable number of streams calculation/storage unit 18 records that the allowable number of streams is zero in the duration between time points t1 and t2. Then, when the transmission unit sends an inquiry for an idle/busy status to the virtual carrier sense unit 15, the carrier state determination unit 19 determines and replies “busy”.

The media access control unit 4 of the wireless communication apparatus STA4 receives the MAC frame (request to send frame RTS1) decoded by the baseband processing unit 3. The reception unit 14 analyzes the MAC header to detect based on frame control information that the frame of interest is the request to send frame, based on duration information that a frame sequence which continues until time point t8 is scheduled, based on the reception address that the transmission destination is the wireless communication apparatus STAT, based on the transmission address that the source of this request to send frame is the wireless communication apparatus STA1, and so forth. Unlike in the first example shown in FIG. 8, the requested number of streams, demultiplexing capacity, transmission power value, and the like cannot be detected since they are not included in the request to send frame RTS1 of the conventional format.

The wireless communication apparatus STA3 also simultaneously monitors the request to send frame RTS1. Since the operation of the wireless communication apparatus STA3 is basically the same as the wireless communication apparatus STA4, a detailed description thereof will not be repeated.

During an interval between time points t3 and t4, the wireless communication apparatus STA4 receives the clear to send frame CTS1 transmitted by the wireless communication apparatus STA7. Since the reception processing by the wireless communication apparatus STA4 is essentially the same as that of the aforementioned request to send frame RTS1, a detailed description thereof will not be repeated. Assume that the reception processing is completed before time point t5.

In this case, unlike in the first example shown in FIG. 8, pieces of information obtained by the wireless communication apparatus STA4 at time point t5 do not suffice to allow the wireless communication apparatuses STA4 and STA3 to make a communication without interfering with the communication between the wireless communication apparatuses STA1 and STA7. This is, for example, for the following reasons.

(1) There is no information associated with the number of streams of the frame DATA1 transmitted by the wireless communication apparatus STA1 and the frame BA1 transmitted by the wireless communication apparatus STA7, and whether or not the wireless communication apparatuses STA4 and STA3 can execute the suppression control of a forward interference to the wireless communication apparatuses STA1 and STA7, and the cancel control of a backward interference from the wireless communication apparatuses STA1 and STA7 within the ranges of their spatial multiplexing/demultiplexing capacities is unknown.

(2) Since the request to send frame RTS1 transmitted by the wireless communication apparatus STA1 and the clear to send frame CTS1 transmitted by the wireless communication apparatus STA7 are transmitted to have a format compatible to the IEEE802.11 standard such as the IEEE802.11a, IEEE802.11g, or IEEE802.11b before introduction of the MIMO technology, they are appended with a preamble for channel estimation only for one antenna. For this reason, assuming that the data frame DATA1 is transmitted using two streams, the channel information between the wireless communication apparatus STA4 and the wireless communication apparatuses STA1 and STA7, and that between the wireless communication apparatus STA3 and the wireless communication apparatuses STA1 and STA7 are insufficient. Because, pieces of channel information at least for two antennas are required to execute the suppression control of a forward interference and the cancel control of a backward interference.

Therefore, the wireless communication apparatuses STA4 and STA3 have to acquire these pieces of insufficient information by another means so as to make concurrent communications based on the spatial division multiplex access.

At time point t5, the wireless communication apparatus STA1 begins to transmit the data frame DATA1 including the number of streams=1 to the wireless communication apparatus STA7. Assume that this transmission is made using the physical frame format and MAC frame format specified by, e.g., the IEEE802.11a.

Since the data frame DATA1 is transmitted using one stream, a preamble used to estimate channel information at least for one antenna is appended to the data frame DATA1. A signal field of a physical layer header, i.e., a PLCP (Physical Layer Convergence Protocol) header of the data frame DATA1 includes MCS (Modulation Coding) information, which helps to reveal the number of streams. By combining information associated with a frame length, MCS information, a channel bandwidth (20 or 40 MHz), an encoding method (Viterbi, LDPC, STBC, etc.), a guard interval length (long or short) of the OFDM, and the like, a duration time of the physical frame can also be detected. That is, since a transmission rate (transmission speed) can be detected from these pieces of information, the frame length is divided by the transmission rate, and an overhead (padding required when the physical layer header or frame length assumes a fraction) attached to the physical frame is added, thus calculating the duration time of the physical frame. Then, assume that it can be calculated that the data frame DATA1 ends at time point t6.

The physical carrier sense unit 9 of the wireless communication apparatus STA4 sends up, based on the above information and calculation result, information indicating that the data frame DATA1 occupies a medium for one stream in a duration from time point t5+α (a slight period of time is required to obtain the above information) to time point t6, to the virtual carrier sense unit 15 of the media access control unit 4. Since the MAC frame is not decoded yet, it is not sure at this time point that the frame is transmitted from the wireless communication apparatus STA1 to the wireless communication apparatus STA7. However, since it is detected that the request to send frame RTS1 and clear to send frame CTS1 have been exchanged between the wireless communication apparatuses STA1 and STA7, it may be estimated that the data frame DATA1 is transmitted from the wireless communication apparatus STA1 to the wireless communication apparatus STA7.

At this time point, the wireless communication apparatuses STA4 and STA3 obtain the following pieces of information.

(LI-1) The wireless communication apparatus STA1 is scheduled to transmit the data frame DATA1 including the number of streams=1 to the wireless communication apparatus STA7 in a duration between time points t5 and t7.

(LI-2) The wireless communication apparatus STA7 is scheduled to transmit the acknowledgement frame BA1 including the maximum number of streams=1 to the wireless communication apparatus STA1 in a duration between time points t7 and t8.

(LI-3) The multiplexing/demultiplexing capacity of the wireless communication apparatus STA1 is unknown. Assume that the wireless communication apparatus STA1 itself is a legacy wireless communication apparatus compliant with the existing wireless LAN standard such as IEEE802.11a, IEEE802.11b, IEEE802.11g, or IEEE802.11n since it exchanges the conventional frames RTS and CTS, and it does not have any functions of suppressing a forward interference to another apparatus, and canceling a backward interference from another apparatus to the self apparatus.

(LI-4) The multiplexing/demultiplexing capacity of the wireless communication apparatus STA7 is unknown. Assume that the wireless communication apparatus STA7 itself is a legacy wireless communication apparatus compliant with the existing wireless LAN standard such as IEEE802.11a, IEEE802.11b, IEEE802.11g, or IEEE802.11n since it exchanges the conventional frames RTS and CTS, and it does not have any functions of suppressing a forward interference to another apparatus, and canceling a backward interference from another apparatus to the self apparatus.

(LI-5) The multiplexing/demultiplexing capacity of the wireless communication apparatus (self apparatus) STA4 is a maximum of 4-stream multiplexing.

(LI-6) No information for a channel state and channel loss between the wireless communication apparatuses STA1 and STA7 is obtained.

(LI-7) A channel state and channel loss between the wireless communication apparatus STA1 and the wireless communication apparatus (self apparatus) STA4 are obtained only for one antenna. Since transmission power is not explicitly detected, the channel loss is an estimated value when the transmission power is assumed.

(LI-8) A channel state and channel loss between the wireless communication apparatus STA7 and the wireless communication apparatus (self apparatus) STA4 are obtained only for one antenna. Since transmission power is not explicitly detected, the channel loss is an estimated value when the transmission power is assumed.

(LI-9) The allowable number of streams in a duration between time points t5 and t6 is a maximum of three streams. However, it is premised on that the spatial multiplexing/demultiplexing unit 11 is controlled at the time of transmission so as not to interfere with the wireless communication apparatus STA7. Also, it is premised on that the spatial multiplexing/demultiplexing unit 11 is controlled to cancel an interference from the wireless communication apparatus STA1 upon reception of a response. In this case, it is estimated that the number of antennas of the wireless communication apparatus STA7 is one. This estimation can be made if an association-related management frame or the like is received in advance. If the apparatus STA7 has two or more antennas, since channel information obtained at this time does not suffice to attain interference suppression, the allowable number of streams is zero.

(LI-10) The allowable number of streams in a duration between time points t6 and t7 is a maximum of four streams.

(LI-11) The allowable number of streams in a duration between time points t7 and t8 is zero. Assume that the wireless communication apparatus (self apparatus) STA4 detects that the wireless communication apparatus STA1 has two antennas since it receives an association-related management frame in advance or receives previously exchanged frames MU-RTS and MU-CTS. Since the channel information between the wireless communication apparatus STA1 and the wireless communication apparatus (self apparatus) STA4 is only for one antenna, it does not suffice to attain interference suppression.

At time point t5+α, the wireless communication apparatus STA4 controls the spatial multiplexing/demultiplexing unit to cancel a signal of the data frame DATA1 transmitted by the wireless communication apparatus STA1 as an interference. This control can be attained by detecting based on the information (LI-1) that the wireless communication apparatus STA1 has started a one-stream communication from time point t5 and using the channel information between the wireless communication apparatus STA1 and self apparatus, which is held by the transmission unit. Such control is required to wait for another frame which may be transmitted from another wireless communication apparatus since it is media access control having random access characteristics. That signal is also used as an input to the physical carrier sense unit 9. A beam to be formed in this way will be referred to as a “predicted waiting beam” hereinafter.

Assume that the wireless communication apparatus STA4 has data to be transmitted to the wireless communication apparatus STA3 at time point t5+α, and starts backoff processing. In reception using the predicted waiting beam, since received power is equal to or smaller than a threshold, the carrier state determination unit can estimate based on this value that only a communication predicted using the information (LI-1) is made. That is, it is determined that the medium is idle, and the decrement processing of a backoff counter advances.

Furthermore, the carrier state determination unit 19 refers to information of the allowable number of streams calculation/storage unit 18, and notifies that a medium for a maximum three streams is continuously idle until time point t6 as long as forward interference suppression to the wireless communication apparatus STA7 is executed at the time of transmission, and an interference from the wireless communication apparatus STA1 is canceled at the time of reception.

Assume that the backoff processing started from time point t5+α is completed at time point s1. The transmission unit of the media access control unit in the wireless communication apparatus STA4 transmits a request to send frame MU-RTS2 to the wireless communication apparatus STA3. The transmission unit 13 controls the spatial multiplexing/demultiplexing unit using channel state information between the wireless communication apparatus (self apparatus) STA4 and the wireless communication apparatus STA1 so that this frame does not interfere with the wireless communication apparatus STA7. Furthermore, the transmission power may be controlled to further reduce an interference with the wireless communication apparatus STAT in consideration of the channel loss information, if necessary.

The baseband processing unit 3 sets a frame length, modulation scheme, and coding scheme of the physical layer header of this frame in accordance with a request from the transmission unit 13 in the media access control unit 4. The end time of this frame is time point s2.

The transmission unit 13 in the media access control unit 4 of the wireless communication apparatus STA4 configures the request to send frame MU-RTS2 as follows. A frame control field includes information indicating that this MAC frame is a request to send frame. In a duration field, a value obtained by subtracting time point s2 from time point s8 is set. In this case, time point s8 is ahead of time point t6, and a duration value is determined in consideration that a medium for three streams is scheduled to be continuously idle until time point t6. Note that the length of a data frame DATA2 which is scheduled to transmit is determined to satisfy this restriction. The address of the wireless communication apparatus STA3 is set in a reception address field, and that of the wireless communication apparatus (self apparatus) STA4 is set in a transmission address field. For the reason described above, the requested number of streams is 3. A demultiplexing capacity field is set with a maximum of 4-stream multiplexing.

Also, information that requests the wireless communication apparatus STA3 to return a channel state is set. Information of transmission power upon transmitting this frame is set. A CRC value is calculated for the entire MAC frame, and is set in the FCS.

At time point t5+α, the wireless communication apparatus STA3 obtains pieces of information equivalent to the pieces of information (LI-1) to (LI-11), and forms a predicted waiting beam according to them. Using the predicted waiting beam, the wireless communication apparatus STA3 can cancel the data frame DATA1 which is being parallelly transmitted by the wireless communication apparatus STAT ahead of the frame to be received as an interference signal, and can demultiplex and receive only the request to send frame MU-RTS2.

Upon reception of the request to send frame MU-RTS2, the wireless communication apparatus STA3 obtains pieces of information equivalent to the pieces of information (LI-1) to (LI-11). The reception unit sends an inquiry to the virtual carrier sense unit, and draws a conclusion that no problem is posed if the requested transmission is permitted. Based on this conclusion, the wireless communication apparatus STA3 transmits a clear to send frame MU-CTS2 that permits the requested transmission to the wireless communication apparatus STA4. The transmission unit controls the spatial multiplexing/demultiplexing unit 11 using the channel information between the wireless communication apparatus (self apparatus) STA3 and the wireless communication apparatus STA7, so that this frame does not interfere with the wireless communication apparatus STA7. Furthermore, the transmission power may be controlled to further reduce an interference with the wireless communication apparatus STA7 in consideration of the channel loss information, if necessary.

The transmission unit 13 in the media access control unit 4 of the wireless communication apparatus STA3 configures the clear to send frame MU-CTS2 as follows. A frame control field includes information indicating that this MAC frame is a clear to send frame. In a duration field, a value obtained by subtracting time point s4 from time point s8 is set. In this case, time point s8 is calculated from the duration of the request to send frame MU-RTS2, and the duration to be permitted is set in consideration that time point s8 is ahead of time point t6 but a medium for three streams is scheduled to be continuously idle until time point t6. The address of the wireless communication apparatus STA4 is set in a reception address field, and that of the wireless communication apparatus (self apparatus) STA3 is set in a transmission address field. For the reason described above, the permitted number of streams is 3. A demultiplexing capacity field is set with a maximum of 4-stream multiplexing. Also, the channel information between the wireless communication apparatus STA4 and the wireless communication apparatus (self apparatus) STA3, which is obtained from the channel estimation unit, is set. Information of transmission power upon transmitting this frame, and the received power of the request to send frame MU-RTS2, which is obtained from the received power measurement unit, are set. A CRC value is calculated for the entire MAC frame, and is set in the FCS.

Using the predicted waiting beam, the wireless communication apparatus STA4 cancels the data frame DATA1 which is being parallelly transmitted by the wireless communication apparatus STA1 ahead of the frame to be received as an interference signal, and demultiplexes and receives the clear to send frame MU-CTS2.

Since the requested transmission is permitted, the transmission unit 13 in the media access control unit 4 of the wireless communication apparatus STA4 transmits a data frame DATA2 to the wireless communication apparatus STA3.

The transmission unit 13 controls the spatial multiplexing/demultiplexing unit 11 using the channel state information between the wireless communication apparatus (self apparatus) STA4 and the wireless communication apparatus STA7, so that this frame does not interfere with the wireless communication apparatus STA7. Furthermore, the transmission power may be controlled to further reduce an interference with the wireless communication apparatus STA7 in consideration of the channel loss information, if necessary.

The transmission unit 13 in the media access control unit 4 of the wireless communication apparatus STA4 configures the data frame DATA2 as follows. Assume that the data frame DATA2 is a data frame, which is expanded, as shown in FIG. 5, in place of the format specified in the conventional IEEE802.11n. A frame control field includes information indicating that this MAC frame is a data frame (or that which is expanded, as shown in FIG. 5). In a duration field, a value obtained by subtracting time point s5 from time point s8 is set. The address of the wireless communication apparatus STA3 is set in a reception address field, and that of the wireless communication apparatus (self apparatus) STA4 is set in a transmission address field. For the reason described above, the number of streams is 3. A demultiplexing capacity field is set with a maximum of 4-stream multiplexing. Also, the channel information between the wireless communication apparatus (self apparatus) STA4 and the wireless communication apparatus STA3, which is obtained from the channel estimation unit, is set. Information of the transmission power upon transmitting this frame, and the received power of the clear to send frame MU-CTS2 obtained from the received power measurement unit are set. Data to be transmitted, which is input from the upper link layer unit 5, is set in a data field. A CRC value is calculated for the entire MAC frame, and this value is set in the FCS.

Using the predicted waiting beam, the wireless communication apparatus STA3 cancels the data frame DATA1 which is being parallelly transmitted by the wireless communication apparatus STA1 ahead of the frame to be received as an interference signal, and demultiplexes and receives the data frame DATA2.

The wireless communication apparatus STA3 configures an acknowledgement frame BA2 according to the reception status of the data frame DATA2, and transmits it to the wireless communication apparatus STA4. That is, a CRC value of the data frame DATA2 is calculated to confirm if the calculated CRC value matches the FCS, i.e., to determine if the data frame DATA2 can be successfully received, and that result is reflected in acknowledgement information of the acknowledgement frame BA2. Note that the data frame DATA2 may include a plurality of re-send units like A-MPDU specified by the IEEE802.11n. In such case, CRC values appended to these units are individually confirmed.

The transmission unit 13 in the media access control unit 4 of the wireless communication apparatus STA3 detects that transmission of the acknowledgement frame BA2 addressed to the wireless communication apparatus STA4 requires a duration from time point s7 to time point s8, and sends an inquiry for an idle/busy status of a medium in this duration to the virtual carrier sense unit 15. The carrier state determination unit 19 refers to the information of the allowable number of streams calculation/storage unit 18 and notifies that a medium for a maximum of three streams is continuously idle until time point t6 as long as a forward interference to the wireless communication apparatus STA7 is suppressed at the time of transmission in a duration between time points t5 and t6. In the end, as for the transmission duration between time points s7 and s8 of the acknowledgement frame BA2, forward interference suppression with respect to the wireless communication apparatus STA7 is required, and the spatial multiplexing/demultiplexing unit 11 is controlled using the channel state information between the wireless communication apparatus (self apparatus) STA3 and the wireless communication apparatus STA7, so that this frame does not interfere with the wireless communication apparatus STA7. Furthermore, the transmission power may be controlled to further reduce an interference with the wireless communication apparatus STA7 in consideration of the channel loss information, if necessary. In the conventional IEEE802.11, when an acknowledgement frame is transmitted in an SIFS (Short Inter Frame Space) immediately after reception of a data frame, confirmation of an idle/busy status is not required. Thus, confirmation of an idle/busy status may be omitted. However, even in such case, forward interference suppression control is required.

Note that it has already been predicted at the time point of returning the clear to send frame MU-CTS2 that as for the transmission duration between time points s7 and s8 of the acknowledgement frame BA2, forward interference suppression with respect to the wireless communication apparatus STA7 is required, and the spatial multiplexing/demultiplexing unit has to be controlled using the channel state information between the wireless communication apparatus (self apparatus) STA3 and the wireless communication apparatus STA7, so that this frame does not interfere with the wireless communication apparatus STA7. Information indicating that the spatial multiplexing/demultiplexing unit is controlled not to interfere with the apparatus STA7 upon transmission of the acknowledgement frame BA2 may be set in advance in the transmission unit 13 in the media access control unit 4, thereby reducing the processing volume (e.g., inquiry processing with respect to the virtual carrier sense unit 15) between reception of the data frame DATA2 and transmission of the acknowledgement frame BA2. In general, making a response in the SIFS requires much time in the processing of the physical layer, and the processing of the MAC layer does not have much time left. Therefore, such setting is effective to implement to immediately return the acknowledgement frame BA2.

Since the wireless communication apparatuses STA3 and STA4 execute control in this way, the communication between the wireless communication apparatuses STA1 and STA7, which was started from time point t1, ends at time point t8 without being interfered by the wireless communication apparatuses STA3 and STA4.

The draft standard of the IEEE802.11n introduces the MIMO technology to IEEE802.11 used so far, and already specifies protocols used to exchange channel states and the like based on such fact. By leveraging this, an example in which a wireless communication apparatus compliant with the IEEE802.11n (draft) standard and a communication apparatus according to the embodiment of the present invention coexist and are connected to each other in an identical frequency channel will be described below.

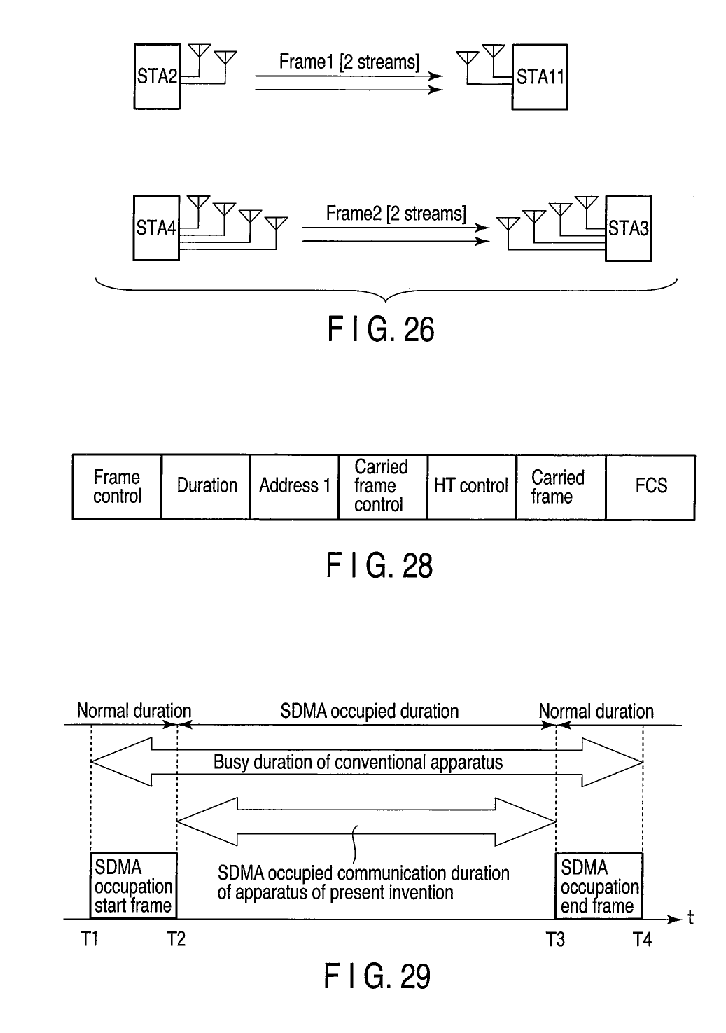

FIG. 25 shows an example of frame exchange to be discussed below. Assume that the wireless communication apparatus STA11 is that compliant with the conventional IEEE802.11n wireless LAN (draft) standard, and the wireless communication apparatuses STA2, STA3, and STA4 are those according to the embodiment of the present invention. This example is different from the first example shown in FIG. 8, the second example shown in FIG. 12, and the third example shown in FIG. 16 in that the wireless communication apparatus STA11 compliant with the conventional wireless LAN standard is mixed. In this example, the wireless communication apparatus STA11 compliant with the conventional wireless LAN standard is different from the wireless communication apparatus STAT compliant with the conventional wireless LAN standard in the fourth example shown in FIG. 20, in that it does not have a function of controlling a plurality of parallel communications but has protocols required to change channel states and the like. The combination contents of assumed wireless communication apparatuses and frame transmissions will be described below in association with the fifth example in which a plurality of wireless communication apparatus pairs including a conventional apparatus parallelly make communications with reference to FIG. 26.

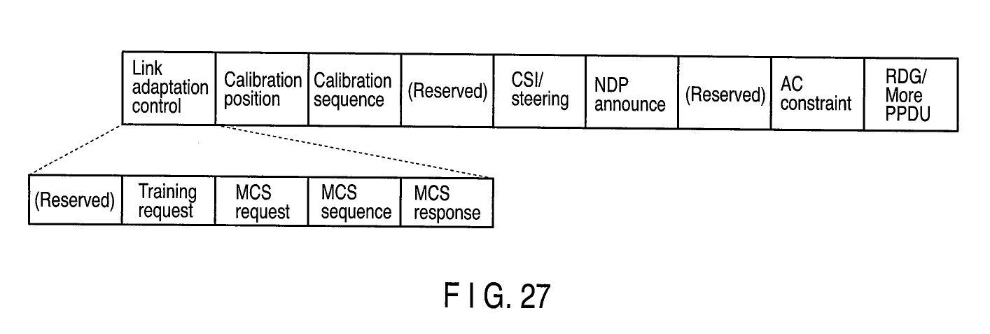

According to the IEEE802.11n standard, a protocol sequence required to exchange channel states can be controlled by, for example, transmitting a MAC frame including an HT control field (HTC: High Throughput Control field). FIG. 27 shows an example of the configuration of the HT control field. The HT control field further includes a Link Adaptation Control field, Calibration Position field, Calibration Sequence field, CSI (Channel State Information)/Steering field, NDP (Null Data Packet) Announce field, AC (Access Category) Constraint field, and RDG (Reverse Direction Grant)/more PPDU (PHY Protocol Data Unit) field. The Link Adaptation Control field includes a Training Request (TRQ) field, MCS request (MAI: MCS request or Antenna Selection Indication) field, MCS sequence (MFSI: MFB Sequence Identifier) field, and MCS response (MFB/ASELC: MCS Feedback and Antenna Selection Command/Data) field.

The HT control field with the above configuration is included in a Control Wrapper frame shown in FIG. 28, or may be included in a data frame or management frame. The Control Wrapper frame is defined to transmit a control frame and the HT control field in combination. A Carried Frame Control field of the Control Wrapper frame is set with a value of a frame control field of a control frame to be carried by the Control Wrapper frame. A Carried Frame field of the Control Wrapper frame is set with a part (except for an FCS) after a first address field of the control frame to be carried by the Control Wrapper frame (excluding the first address field).

Note that a frame RTS1(HTC) transmitted by the wireless communication apparatus STA2 and a frame CTS1(HTC) transmitted by the wireless communication apparatus STA11 are respectively transmitted by wrapping the frames RTS (FIG. 23) and CTS (FIG. 24) by the Control Wrapper frames together with the HT control fields.

As described above, in the fourth example shown in FIG. 20 including the wireless communication apparatus STAT compliant with the conventional wireless LAN standard, pieces of information obtained by the wireless communication apparatus STA4 at time point t5 are restricted compared to a case in which all wireless communication apparatuses involved in communications have a function of parallelly making communications according to the embodiment of the present invention, and do not suffice to allow the wireless communication apparatuses STA4 and STA3 to make a communication concurrently with an existing communication so as not to interfere with the existing communication.

However, in the fifth example shown in FIG. 26, sufficient information may often be obtained at time point t5. For example, this is the case when the frames RTS1(HTC) and CTS1(HTC) are transmitted as channel estimation physical frames (sounding PPDU) specified in the IEEE802.11n (draft) standard. Note that “sounding PPDU” is a physical frame used to allow wireless communication apparatuses which receive that frame (including those other than the destination) to estimate channels between antennas of transmitting and receiving wireless communication apparatuses, and is characterized by including a known signal (which configures a part of a preamble) required for channel estimation in association with all transmission antennas of the transmitting wireless communication apparatus, so as to allow channel estimation. The known signal included in the preamble is allocated so that a known signal transmitted from each antenna can be demultiplexed, even when the receiving wireless communication apparatus does not have any channel information at that time point. A practical configuration example of the preamble may be that specified by, e.g., the IEEE802.11n (draft) standard.

The insufficient points (1) and (2) of information at time point t5 described in the fourth example shown in FIG. 20 can be respectively resolved as follows.

(1′) Information indicating whether or not a frame of interest is a sounding PPDU, and the number of antennas to be excited (the number of streams) are included in a signal field of a physical header, and the wireless communication apparatuses STA3 and STA4 can detect that the frames RTS1(HTC) and CTS1(HTC) are sounding PPDUs, and the maximum number of antennas (the number of streams) of the wireless communication apparatuses STA2 and STA11. According to the definition of the sounding PPDU, since the numbers of streams of a frame DATA1 transmitted by the wireless communication apparatus STA2 and a frame BA1 transmitted by the wireless communication apparatus STA11 do not exceed the maximum number of antennas (the number of streams), the wireless communication apparatuses STA4 and STA3 can determined on the premise of this whether or not the suppression control of a forward interference to the wireless communication apparatuses STA2 and STA11 and the cancel control of a backward interference from the wireless communication apparatuses STA2 and STA11 can be executed within the ranges of their spatial multiplexing/demultiplexing capacities.

(2′) The request to send frame RTS1(HTC) transmitted by the wireless communication apparatus STA2 and the clear to send frame CTS1(HTC) transmitted by the wireless communication apparatus STA11 are transmitted as sounding PPDUs. For this reason, the channel information between the wireless communication apparatus STA4 and the wireless communication apparatuses STA2 and STA11, and that between the wireless communication apparatus STA3 and the wireless communication apparatuses STA2 and STA11 suffice to execute the suppression control of a forward interference and to cancel a backward interference.

Thus, at the time point t5, the wireless communication apparatuses STA3 and STA4 in the fifth example have essentially the same information as in the first example shown in FIG. 8. The conventional wireless communication apparatus STA11 according to the IEEE802.11n (draft) specification does not have functions of suppressing a forward interference and canceling a backward interference by itself. However, in the situation of the fifth example, these functions are not required (only the wireless communication apparatuses STA3 and STA4 suppress a forward interference and cancel a backward interference). Thus, the subsequent communications can progress in the same manner as in the first example.

On the other hand, in some cases, concurrent communications have to be made by expecting the function of suppressing a forward interference and that of canceling a backward interference included in a wireless communication apparatus which is making a communication on ahead. For example, the wireless communication apparatus STA6 of the second example shown in FIG. 12 corresponds to such case. If the wireless communication apparatus STA6 of the second example is replaced by a conventional wireless communication apparatus, even when that apparatus includes four antennas and can cope with a maximum of four streams, when the apparatus does not have a function of suppressing a forward interference and that of canceling a backward interference, concurrent communications cannot be made. The wireless communication apparatus according to the embodiment of the present invention has to determine, in consideration of not only the maximum number of streams of each wireless communication apparatus but also information indicating whether or not the wireless communication apparatus of interest has a function of suppressing a forward interference and that of canceling a backward interference, whether or not a concurrent communication can be added to a preceding communication later.

Note that the wireless communication apparatus STA2 according to the embodiment of the present invention can instruct the conventional wireless communication apparatus STA11 according to the IEEE802.11n (draft) specification to transmit a sounding PPDU using an HTC training request. As a result, even when the conventional wireless communication apparatus is mixed, the chance of concurrently making a plurality of communications is increased, thus improving the communication efficiency.

When the conventional wireless communication apparatus is mixed, since a case still remains in which the communication efficiency cannot be improved using the spatial division multiplex access by the wireless communication apparatus according to the embodiment of the present invention, the conventional wireless communication apparatus and the wireless communication apparatus according to the embodiment of the present invention may time-divisionally coexist, as shown in FIG. 29. For this purpose, for example, a spatial division multiplex access (SDMA) occupation start frame is defined, and the wireless communication apparatus according to the embodiment of the present invention transmits this frame, so as to make the conventional wireless communication apparatus recognize that a duration between time points T1 and T4 is busy by a virtual carrier sense, and to make the wireless communication apparatus according to the embodiment of the present invention recognize that a duration between time points T2 and T3 is an SDMA occupied duration.

In the SDMA occupied duration, only the wireless communication apparatuses according to the embodiment of the present invention make communications in the mode described in, e.g., the first example shown in FIG. 8, the second example shown in FIG. 12, or the third example shown in FIG. 16. An SDMA occupation end frame may be defined, and the wireless communication apparatus according to the embodiment of the present invention may transmit this frame to announce that the SDMA occupied duration ends at time point T4. Alternatively, the end of the busy duration detected by the virtual carrier sense may simultaneously indicate the end of the SDMA occupied duration without using any SDMA occupation end frame. In the latter case, for example, by transmitting an existing CF-end frame, the busy duration may be shortened, and the SDMA occupied duration may end. It is effective to explicitly end the SDMA occupied duration by transmitting the SDMA occupation end frame or CF-end frame when communications between the wireless communication apparatuses according to the embodiment of the present invention are less than expected. Note that a frame sequence that combines a plurality of frames may be used to start and end a duration. For example, in order to reduce hidden terminals, a frame exchange sequence similar to that using frames RTC and CTS may be used to start and end a duration. Also, only a base station may control to start and end a duration.

Furthermore, even when the conventional wireless communication apparatus and the wireless communication apparatus according to the embodiment of the present invention time-divisionally coexist in this way, the wireless communication apparatus according to the embodiment of the present invention may make a communication concurrently with the conventional wireless communication apparatus in the mode described in, e.g., the fourth example shown in FIG. 20 or the fifth example shown in FIG. 26 in a normal duration before time point T1 or that after time point T4.

In the above description, the number of time-serially possible streams is calculated under the precondition that an acknowledgement frame is returned in response to transmission of a Data frame. However, Data frames may be exchanged in two ways using an RDG (Reverse Direction Grant) included in the HT control field. That is, when an HT field set with the RDG is inserted in a received Data frame, a wireless communication apparatus on the receiving side not only returns an acknowledgement response, but also responds a Data frame within a transmission opportunity (TXOP) limit. When a communication is made concurrently with this communication, since a response frame length is indefinite, the number of time-serially possible streams has to be calculated in consideration of this fact. In one method, concurrent communications are interrupted within a range of a Data frame length set with the RDG, and are restarted if possible when the length of that response frame is revealed. In another method, concurrent communications are made within a transmission opportunity (TXOP) limit. In the latter case, since the transmission and reception roles of the wireless communication apparatus pair making a preceding communication are switched in the middle of the concurrent communications (as in the third example shown in FIG. 16), demands for the forward interference suppression capacity and backward interference cancellation capacity increase compared to the former case (similar to the first example shown in FIG. 8).

When the RDG is used, it is effective to especially use the expanded DATA frame structure shown in FIG. 5. For example, even when the exchange sequence of frames MU-RTS and MU-CTS is omitted, DATA frames can be exchanged in two ways using the RDG. Thus, once an expanded DATA frame is exchanged between two wireless communication apparatuses, information nearly equivalent to that obtained when the frames MU-RTS and MU-CTS are exchanged can be provided to other surrounding wireless communication apparatuses. After that, concurrent communications described in detail in this embodiment can be executed. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
a first storage to store a first number of streams which are capable of being demultiplexed by the wireless communication apparatus in present and future communications of a time series;
a first acquisition unit configured to acquire a second number of streams which are capable of being demultiplexed by a first wireless communication apparatus involved in the communications;
a second acquisition unit configured to acquire a third number of sum of streams of communications at a time point of the time series performed by the wireless communication apparatus and the first wireless communication apparatus;
a second storage to store, if the first number of streams exceeds the third number of streams, a difference between the first number of streams and the third number of streams as an allowable number of streams; and
a determination unit configured to determine that a wireless medium is idle, in the case where a fourth number of streams required for the wireless communication apparatus to perform a new communication is not more than the allowable number of streams.

2. The apparatus according to claim 1, further comprising a first calculation unit configured to calculate the allowable number of streams independently of the second number of streams, and
wherein the second number of streams indicates a stream demultiplexing capacity of the first wireless communication apparatus which consistently performs a transmission during transmission of the wireless communication apparatus.

3. The apparatus according to claim 1, further comprising a second calculation unit configured to calculate the allowable number of streams in consideration of the second number of streams, and
wherein the second number of streams indicates a stream demultiplexing capacity of the first wireless communication apparatus which performs a reception during transmission of the wireless communication apparatus.

4. The apparatus according to claim 1, further comprising a third calculation unit configured to calculate, when a number of streams of a desired signal of the first wireless communication apparatus falls below the second number of streams, the allowable number of streams under a precondition that at least some of surplus streams are used to cancel an interference signal,
wherein the second number of streams indicates stream demultiplexing capacity of the first wireless communication apparatus which performs a reception during transmission of the wireless communication apparatus.

5. The apparatus according to claim 1, further comprising a fourth calculation unit configured to calculate, when a number of streams transmitted by the wireless communication apparatus falls below the first number of streams, the allowable number of streams under a precondition that at least some of surplus streams are used to cancel an interference to the first wireless communication apparatus,
wherein the first number of streams indicates a stream demultiplexing capacity of the wireless communication apparatus.

6. The apparatus according to claim 1, further comprising a fifth calculation unit configured to calculate, when a number of streams transmitted by the first wireless communication apparatus falls below the second number of streams, the allowable number of streams under a precondition that at least some of surplus streams are used to cancel an interference to a second wireless communication apparatus or the wireless communication apparatus,
wherein the second number of streams indicates a stream demultiplexing capacity of the first wireless communication apparatus.

7. The apparatus according to claim 1, further comprising a first transmission unit configured to transmit a frame including an identifier of the wireless communication apparatus and a stream demultiplexing capacity of the wireless communication apparatus.

8. The apparatus according to claim 1, further comprising a second transmission unit configured to transmit a frame including the number of streams of a given frame or a frame scheduled to be transmitted after the given frame, a duration time thereof, an identifier of a destination wireless communication apparatus, and an identifier of the wireless communication apparatus.

9. The apparatus according to claim 1, further comprising a third transmission unit configured to transmit a frame including the number of streams of a frame scheduled to be received by the wireless communication apparatus after a given frame, a duration time thereof, an identifier of a source wireless communication apparatus, and an identifier of the wireless communication apparatus.

10. The apparatus according to claim 1, further comprising a first estimation unit configured to estimate stream demultiplexing capacity as the second number of streams.

11. The apparatus according to claim 1, further comprising a second estimation unit configured to estimate the third number of streams.

12. The apparatus according to claim 1, wherein allowable number of streams for reception and allowable number of streams for transmission are independently calculated as the allowable numbers of streams.

13. The apparatus according to claim 1, wherein the allowable number of streams is calculated in correspondence with each wireless communication apparatus of a communication partner.

14. A wireless communication method comprising steps of:
storing a first number of streams which are capable of being demultiplexed by the wireless communication apparatus in present and future communications of a time series;
acquiring a second number of streams which are capable of being demultiplexed by a first wireless communication apparatus involved in the communications;
acquiring a third number of sum of streams of communications at a time point of the time series performed by the wireless communication apparatus and the first wireless communication apparatus;
if the first number of streams exceeds the third number of streams, storing a difference between the first number of streams and the third number of streams as an allowable number of streams; and
determining that a wireless medium is idle, in the case where a fourth number of streams required for the wireless communication apparatus to perform a new communication is not more than the allowable number of streams.

15. A wireless communication apparatus comprising:
a first storage to store a first number of streams which are capable of being demultiplexed by the wireless communication apparatus;
a first acquisition unit configured to acquire a second number of streams which are capable of being demultiplexed by a first wireless communication apparatus;
a second acquisition unit configured to acquire a third number of sum of streams of communications at a time point of the time series performed by the wireless communication apparatus and the first wireless communication apparatus;
a second storage to store if the first number of streams exceeds the third number of streams, a difference between the first number of streams and the third number of streams as an allowable number of streams; and
a determination unit configured to determine that a wireless medium is idle, in the case where a fourth number of streams required for the wireless communication apparatus to perform a new communication is not more than the allowable number of streams.
